(19) United States
(12) Patent Application Publication
(10) Pub. No.: US 2015/0368153 A1
(43) Pub. Date: Dec. 24, 2015

(54) STRENGTHENED GLASS WITH DEEP DEPTH OF COMPRESSION

(71) Applicant: Corning Incorporated, Corning, NY (US)

(72) Inventors: Jonathan David Pesansky, Corning, NY (US); Kevin Barry Reiman, Horseheads, NY (US); Rostislav Vatchev Roussev, Painted Post, NY (US)

(21) Appl. No.: 14/740,896

(22) Filed: Jun. 16, 2015

Related U.S. Application Data
(60) Provisional application No. 62/014,464, filed on Jun. 19, 2014.

(51) Int. Cl. C03C 21/00; C03C 4/18; C03C 3/093; C03C 3/091; C03C 3/097

(52) U.S. Cl. CPC C03C 21/002; C03C 3/091; C03C 3/097; C03C 3/093; C03C 4/18; C03C 2204/00

(57) ABSTRACT

Chemically strengthened glass articles having at least one deep compressive layer extending from a surface of the article to a depth of at least about 45 μm within the article are provided. In one embodiment, the compressive stress profile includes a single linear segment extending from the surface to the depth of compression DOC. Alternatively, the compressive stress profile includes two linear portions: the first portion extending from the surface to a relatively shallow depth and having a steep slope; and a second portion extending from the shallow depth to the depth of compression. Methods of achieving such stress profiles are also described.

This application claims the benefit of priority under 35 U.S.C. §119 of U.S. Provisional Application Ser. No. 62/014,464, filed on Jun. 19, 2014, the content of which is relied upon and incorporated herein by reference in its entirety.

### BACKGROUND

The disclosure relates to a chemically strengthened glass article. More particularly, the disclosure relates to chemically strengthened glasses having a deep compressive surface layer.

Strengthened glasses widely used in electronic devices as cover plates or windows for portable or mobile electronic communication and entertainment devices, such as cellular phones, smart phones, tablets, video players, information terminal (IT) devices, laptop computers and the like, as well as in other applications. As strengthened glasses are increasingly being utilized, it has become more important to develop strengthened glass materials having improved survivability, especially when subjected to tensile stresses and/or relatively deep flaws caused by contact with hard/sharp surfaces.

### SUMMARY

Chemically strengthened glass articles having at least one deep compressive layer extending from a surface of the article to a depth of at least about 45 μm within the article are provided. In one embodiment, the compressive stress profile includes a single linear segment extending from the surface to the depth of compression DOC. Alternatively, the compressive stress profile includes two approximately linear portions: the first portion extending from the surface to a relatively shallow depth and having a steep slope; and a second portion extending from the shallow depth to the depth of compression. Methods of achieving such stress profiles are also described.

Accordingly, one aspect of the disclosure is to provide a glass article, having a compressive region having a compressive stress CSₛ of at least about 150 MPa at a surface of the glass article. The compressive region extends from the surface to a depth of compression DOC of at least about 45 μm and has a compressive stress profile and a compressive stress profile having a first portion a extending to a depth dₐ of at least about 45 μm from the surface and having a slope mₐ, wherein 2 MPa/μm≦mₐ≦8 MPa/μm, and optionally a second portion a′ extending from the surface to a depth d_{a′} of at least about 3 μm, wherein 40 MPa/μm≦m_{a′}≦200 MPa/μm.

A second aspect of the disclosure is to provide a glass article having a compressive layer having a compressive stress CSₛ of at least about 150 MPa at a surface of the glass article. The compressive layer extends from the surface to a depth of compression DOC of at least about 45 μm and has a compressive stress profile. The compressive stress profile comprises: a first portion a extending from the surface to a depth dₐ and having a slope mₐ, wherein 3 μm≦dₐ≦8 μm and 40 MPa/μm≦mₐ≦200 MPa/μm; and a second portion b extending from dₐ to up to the depth of compression DOC and having a slope m_{b}, wherein 2 MPa/μm≦m_{b}≦8 MPa/μm.

In a third aspect, a glass article having a compressive region having a compressive stress CSₛ of at least about 150 MPa at a surface of the glass article is provided. The compressive region extends from the surface to a depth of compression DOC of at least about 45 μm and has a compressive stress profile. The compressive stress profile has a first portion a extending from the surface to a depth dₐ and a slope mₐ, wherein the depth dₐ is equal to the depth of compression and 2 MPa/μm≦mₐ≦8 MPa/μm.

A fourth aspect of the disclosure is to provide a glass article having a compressive region under a compressive stress CSₛ of at least about 120 MPa at a surface of the glass article. The compressive region extends from the surface to a depth of compression DOC of at least about 100 μm and has a compressive stress profile. The compressive stress profile has a first linear portion a extending from the surface to a depth dₐ and a slope mₐ, wherein the depth dₐ is equal to the depth of compression and 0.7 MPa/μm≦mₐ≦2.0 MPa/μm.

A fifth aspect of the disclosure is to provide a method of producing a strengthened glass article having at least one compressive stress layer extending from a surface of the strengthened glass article to a depth of compression DOC of at least about 45 μm. The method comprises: conducting a first ion exchange step by immersing an alkali aluminosilicate glass article in a first ion exchange bath at a temperature of greater than 400° C. for a time sufficient such that the compressive stress layer has a depth of at least 45 μm after the first ion exchange step; and conducting a second ion exchange step by immersing the alkali aluminosilicate glass article in a second ion exchange bath different from the first ion exchange bath at a temperature of at least about 350° C. for a time sufficient to produce the compressive layer having the depth of compression DOC of at least about 45 μm.

These and other aspects, advantages, and salient features will become apparent from the following detailed description, the accompanying drawings, and the appended claims.

### BRIEF DESCRIPTION OF THE DRAWINGS

FIG. 1 is a schematic cross-sectional view of a chemically strengthened glass article;

FIG. 2 is a schematic representation of a compressive stress profile obtained by a single step ion exchange process;

FIG. 3 is a schematic representation of a compressive stress profile obtained by a two-step ion exchange process;

FIG. 4a is a plot of spectra of refractive index profiles for TM and TE polarization reconstructed form the respective TM and TE spectra of bound optical modes measured for ion exchanged glass sample a having a thickness of 0.4 mm;

FIG. 4b is a plot of the compressive stress profile determined from the index profiles shown in FIG. 4a;

FIG. 5a is a plot of TM and TE refractive index profiles reconstructed from spectra of bound optical modes for TM and TE polarization measured for ion exchanged glass sample b having a thickness of 0.4 mm;

FIG. 5b is a plot of the compressive stress profile determined from the spectra shown in FIG. 5a;

FIG. 5c is a plot of the compressive stress profile of the sample in FIGS. 5a and 5b following a second ion exchange step;

FIG. 6a is a plot of TM and TE refractive index profiles reconstructed from spectra of bound optical modes for TM and TE polarization measured for ion exchanged glass sample c having a thickness of 0.4 mm;

FIG. 6b is a plot of the compressive stress profile determined from the spectra shown in FIG. 6a;

FIG. 7a is a plot of TM and TE refractive index profiles reconstructed from spectra of bound optical modes for TM and TE polarization measured for ion exchanged glass sample d having a thickness of 0.5 mm;

FIG. 7b is a plot of the compressive stress profile determined from the spectra shown in FIG. 7a;

FIG. 8a is a plot of TM and TE refractive index profiles reconstructed from spectra of bound optical modes for TM and TE polarization measured for ion exchanged glass sample e having a thickness of 0.5 mm;

FIG. 8b is a plot of the compressive stress profile determined from the spectra shown in FIG. 8a;

FIG. 9a is a plot of the compressive stress profile for ion exchanged glass sample f having a thickness of 0.7 mm;

FIG. 9b is a plot of the compressive stress profile of the sample in in FIG. 9a following a second ion exchange step;

FIG. 10a is a plot of the compressive stress profile for ion exchanged glass sample g having a thickness of 0.8 mm;

FIG. 10b is a plot of the compressive stress profile of the sample in FIG. 10a following a second ion exchange step;

FIG. 11 is a plot of the compressive stress profile for ion exchanged glass sample i having a thickness of 0.9 mm following two ion exchange steps;

FIG. 12a is a plot of the compressive stress profile for ion exchanged glass sample j having a thickness of 1.0 mm;

FIG. 12b is a plot of the compressive stress profile determined for the sample of FIG. 12a following a second ion exchange step;

FIG. 13a is a plot of the compressive stress profile for ion exchanged glass sample k having a thickness of 0.55 mm;

FIG. 13b is a plot of the compressive stress profile determined for the sample of FIG. 13a following a second ion exchange step;

FIG. 14a is a graphical representation of a photograph showing strengthened glass articles 1) exhibiting frangible behavior upon fragmentation; and 2) exhibiting non-frangible behavior upon fragmentation;

FIG. 14b is a graphical representation of a photograph showing strengthened glass sheets that exhibit non-frangible behavior upon fragmentation; and

FIG. 15 is a graphical comparison of the drop test failure rate of strengthened glasses at varying DOL values on asphalt according to one or more embodiments of the present disclosure;

FIG. 16 is a plot of the compressive stress profile for ion exchanged glass sample 1 having a thickness of 0.8 mm;

FIG. 17 is a plot of the compressive stress profile for ion exchanged glass sample m having a thickness of 0.8 mm; and

FIG. 18 is a plot of drop height at failure as a function of depth of layer DOL, as measured by FSM, of ion exchanged glass samples

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

As used herein, the terms “glass article” and “glass articles” are used in their broadest sense to include any object made wholly or partly of glass. Unless otherwise specified, all glass compositions are expressed in terms of mole percent (mol %) and all ion exchange compositions are expressed in terms of weight percent (wt %).

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, a glass that is “substantially free of MgO” is one in which MgO is not actively added or batched into the glass, but may be present in very small amounts as a contaminant.

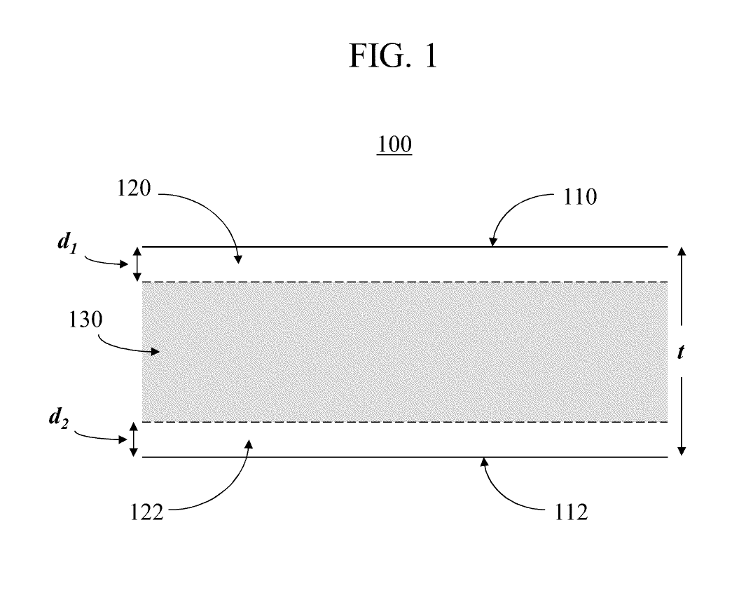

Referring to the drawings in general and to FIG. 1 in particular, it will be understood that the illustrations are for the purpose of describing particular embodiments and are not intended to limit the disclosure or appended claims thereto. The drawings are not necessarily to scale, and certain features and certain views of the drawings may be shown exaggerated in scale or in schematic in the interest of clarity and conciseness.

As used herein, the terms “depth of layer” and “DOL” refer to the depth of the compressive layer as determined by surface stress meter (FSM) measurements using commercially available instruments such as the FSM-6000.

As used herein, the terms “depth of compression” and “DOC” refer to the depth at which the stress within the glass changes from compressive to tensile stress. At the DOC, the stress crosses from a positive (compressive) stress to a negative (tensile) stress and thus has a value of zero.

According to the scientific convention normally used in the art, compression is expressed as a negative (<0) stress and tension is expressed as a positive (>0) stress. Throughout this description, however, compressive stress CS is expressed as a positive or absolute value—i.e., as recited herein, CS=|CS| and central tension or tensile stress is expressed as a negative value in order to better visualize the compressive stress profiles described herein.

As used herein, the “slope (m)” refers to the slope of a segment or portion of the stress profile that closely approximates a straight line. The predominant slope is defined as the average slope for regions that are well approximated as straight segments. These are regions in which the absolute value of the second derivative of the stress profile is smaller than the ratio of the absolute value of the first derivative, and approximately half the depth of the region. For a steep, shallow segment of the stress profile near the surface of the strengthened glass article, for example, the essentially straight segment is the portion for each point of which the absolute value of the second derivative of the stress profile is smaller than the absolute value of the local slope of the stress profile divided by the depth at which the absolute value of the stress changes by a factor of 2. Similarly, for a segment of the profile deeper within the glass, the straight portion of the segment is the region for which the local second derivative of the stress profile has an absolute value that is smaller than the absolute value of the local slope of the stress profile divided by half the DOC.

For typical stress profiles, this limit on the second derivative guarantees that the slope changes relatively slowly with depth, and is therefore reasonably well defined and can be used to define regions of slope that are important for the stress profiles that are considered advantageous for drop performance.

Let the stress as profile a function of depth x be given by the function

σ=σ(x) (1),

let the first derivative of the stress profile with respect to depth be

$${σ}^{′} = \frac{d σ}{dx} , \qquad ( 2 )$$

and the second derivative be

$${σ}^{″} = \frac{{d}^{2} σ}{{dx}^{2}} . \qquad ( 3 )$$

If a shallow segment extends approximately to a depth dₛ, then for the purposes of defining a predominant slope, a straight portion of the profile is a region where

$$\vert {σ}^{″} ( x ) \vert < \vert 2 \frac{{σ}^{′} ( x )}{{d}_{s}} \vert . \qquad ( 4 )$$

If a deep segment extends approximately to a larger depth DOC, or to a larger depth d_{d}, or to a depth DOL in traditional terms, then a straight portion of the profile is a region where

$$\vert {σ}^{″} ( x ) \vert < \vert 2 \frac{{σ}^{′} ( x )}{{d}_{d}} \vert \approx \vert 2 \frac{{σ}^{′} ( x )}{D O C} \vert \approx \vert 2 \frac{{σ}^{′} ( x )}{D O L} \vert . \qquad ( 5 )$$

The latter equation is also valid for a 1-segment stress profile obtained by a single ion exchange in a salt containing only a single alkali ion other than the ion being replaced in the glass for chemical strengthening.

Preferably, the straight segments are selected as regions where

$$\vert {σ}^{″} ( x ) \vert < \vert \frac{{σ}^{′} ( x )}{d} \vert , \qquad ( 6 )$$

where d stands for the relevant depth for the region, shallow or deep.

The slope m of linear segments of the compressive stress profiles described herein are given as absolute values of the slope

$$\frac{d σ}{dx} - i . e . ,$$

m, as recited herein, is equal to

$$\vert \frac{d σ}{dx} \vert .$$

More specifically, the slope m represents the absolute value of the slope of a profile for which the compressive stress generally decreases as a function of increasing depth.

Described herein are glass articles that are chemically strengthened by ion exchange to obtain a prescribed compressive stress profile and thus achieve survivability when dropped onto a hard, abrasive surface from a prescribed height.

Ion exchange is commonly used to chemically strengthen glasses. In one particular example, alkali cations within a source of such cations (e.g., a molten salt, or “ion exchange,” bath) are exchanged with smaller alkali cations within the glass to achieve a layer that is under a compressive stress (CS) near the surface of the glass. For example, potassium ions from the cation source are often exchanged with sodium ions within the glass. The compressive layer extends from the surface to a depth within the glass.

A cross-sectional schematic view of a planar ion exchanged glass article is shown in FIG. 1. Glass article 100 has a thickness t, first surface 110, and second surface 112. While the embodiment shown in FIG. 1 depicts glass article 100 as a flat planar sheet or plate, glass article may have other configurations, such as three dimensional shapes or non-planar configurations. Glass article 100 has a first compressive region 120 extending from first surface 110 to a depth of compression (DOC) d₁ into the bulk of the glass article 100. In the embodiment shown in FIG. 1, glass article 100 also has a second compressive region 122 extending from second surface 112 to a second depth of compression (DOC) d₂. Glass article also has a central region 130 that extends from d₁ to d₂. Central region 130 is under a tensile stress having a value at the center of the central region 130 called central tension or center tension (CT). The tensile stress of region 130 balances or counteracts the compressive stresses of regions 120 and 122. The depths d₁, d₂ of first and second compressive regions 120, 122 protect the glass article 100 from the propagation of flaws introduced by sharp impact to first and second surfaces 110, 112 of glass article 100, while the compressive stress minimizes the likelihood of a flaw growing and penetrating through the depth d₁, d₂ of first and second compressive regions 120, 122.

The strengthened glass articles described herein have a maximum compressive stress CSₛ of at least about 150 megaPascals (MPa). In some embodiments, the maximum compressive stress CSₛ is at least about 210 MPa and, in other embodiments, at least about 300 MPa. In some embodiments, the maximum compressive stress CSₛ is located at the surface (110, 112 in FIG. 1). In other embodiments, however, the maximum compressive CSₛ may be located in the compressive region (120, 122) at some depth below the surface of the glass article. The compressive region extends from the surface of the glass article to a depth of compression DOC of at least about 45 microns (μm). In some embodiments, DOC is at least about 60 μm. In other embodiments, DOC is at least about 70 μm, in some embodiments, at least about 80 μm, and, in still other embodiments, DOC is at least about 90 μm. In certain embodiments, the depth of compression DOC is at least 100 μm and, in some embodiments at least about 140 μm. In certain embodiments, the depth of compression has a maximum value of about 100 μm.

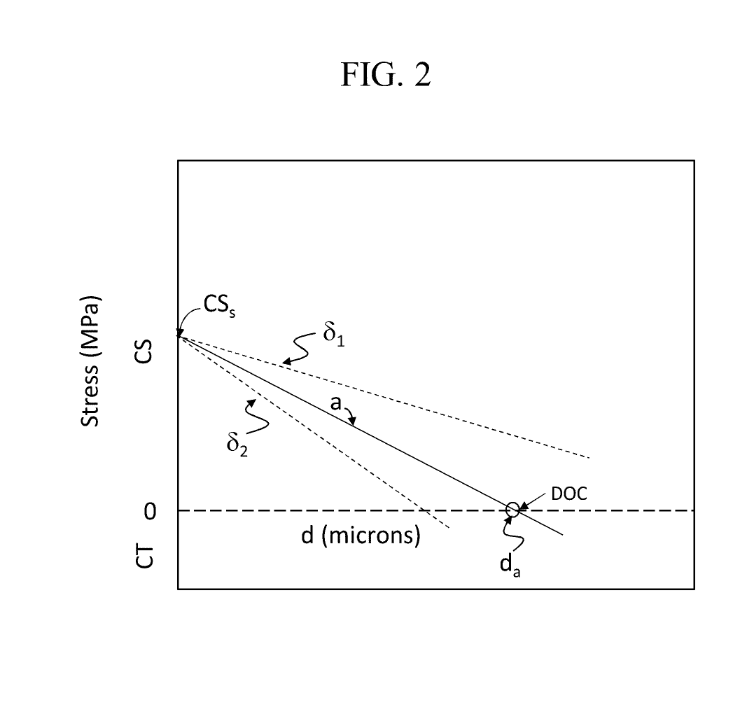

The compressive stress varies as a function of depth below the surface of the strengthened glass article, producing a compressive stress profile in the compressive region. In some embodiments, the compressive stress profile is substantially linear within the compression region, as schematically shown in FIG. 2. In FIG. 2, the compressive stress behaves substantially linearly, resulting in a straight line a having a slope mₐ, expressed in MPa/μm, that intercepts the vertical y (CS) axis at CSₛ. CS profile a intercepts the x axis at the depth of compression DOC. At this point, the total stress is zero. Below DOC, the glass article is in tension CT, reaching a central value CT. In one non-limiting example, there may be a sub-region over which the tension varies from 0 up to a maximum (by absolute value) tension equal to CT, and a region over which the tension is substantially constant, equal to CT.

In some embodiments, the compressive stress profile a of the glass article described herein has a slope mₐ that is within a specified range. In FIG. 2, for example, slope mₐ of line a lies between upper boundary δ₂ and lower boundary δ₁; i.e., δ₂≧mₐ≧δ₁. In some embodiments, 2 MPa/μm≦mₐ≦200 MPa/μm. In some embodiments, 2 MPa/μm≦mₐ≦8 MPa/μm, in some embodiments, 3 MPa/μm≦mₐ≦6 MPa/μm, and in still other embodiments, 2 MPa/μm≦mₐ≦4.5 MPa/μm.

In certain embodiments, the slope mₐ is less than about 1.5 MPa/μm and, in some embodiments, from about 0.7 MPa/μm to about 2 MPa/μm. When the slope mₐ has such values and the depth of compression DOC is at least about 100 μm, the resistance of the strengthened glass to at least one type of failure modes (e.g., very deep puncture) that may be prevalent in field failures certain device designs is particularly advantageous.

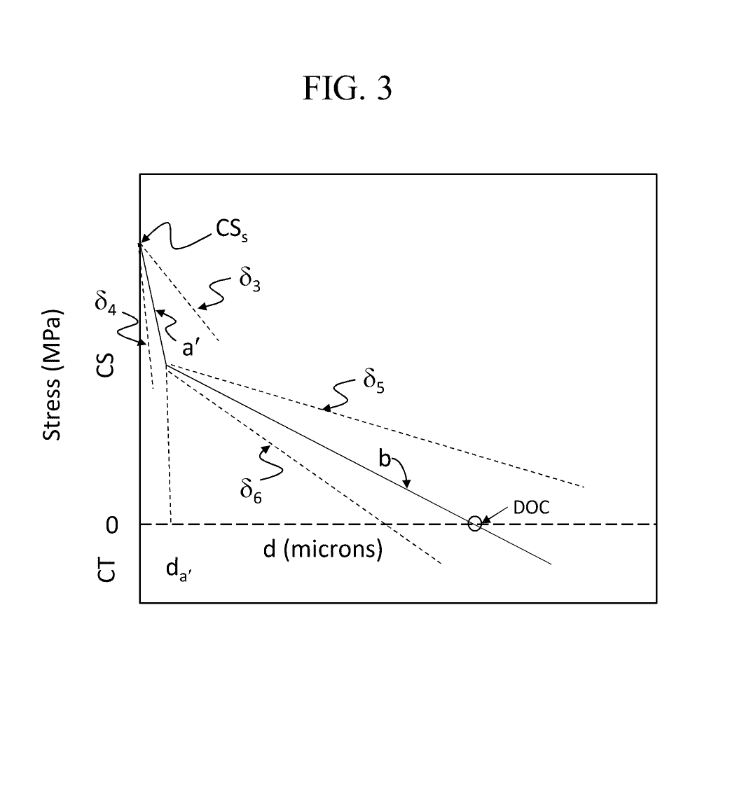

In other embodiments, the compressive stress profile is a combination of more than one substantially linear function, as schematically shown in FIG. 3. As seen in FIG. 3, the compressive stress profile has a first segment or portion a′ and a second segment or portion b. First portion a exhibits substantially linear behavior from the strengthened surface of the glass article to a depth dₐ. Portion a′ has a slope m_{a′} and y intercept CSₛ. Second portion b of the compressive stress profile extends from approximately depth dₐ to depth of compression DOC, and has a slope m_{b}. The compressive stress CS(dₐ) at depth dₐ is given by the expression

CS(dₐ)≈CSₛ−dₐ(m_{a′}) (7).

In some embodiments, depth dₐ is in a range from about 3 μm to about 8 μm; i.e., 3 μm≦dₐ≦8 μm. In other embodiments, 3 μm≦dₐ≦10 μm. In yet other embodiments, 3 μm≦dₐ≦12 μm.

It will be appreciated by those skilled in the art that the present disclosure is not limited to compressive stress profiles consisting of only two distinct portions. Instead, the compressive stress profile may include additional segments. In some embodiments, different linear portions or segments of the compressive stress profile may be joined by a transitional region (not shown) in which the slope of the profile transitions from a first slope to a second slope (e.g., from m_{a′} to m_{b}).

As shown in FIG. 3, the slope of portion a′ of the compressive stress profile is much steeper than the slope of portion b—i.e., |m_{a′}|≧|m_{b}|. This corresponds to a condition in which a compressive stress profile having a “spike” at the surface of the glass article is created by multiple ion exchange processes carried out in succession in order to provide the surface with sufficient compressive stress to withstand the introduction or growth of some flaws produced through impact.

In some embodiments, the compressive stress profiles a and b of the glass article described herein have slopes m_{a′} and m_{b}, respectively, that are within specified ranges. In FIG. 3, for example, slope m_{a′} of line a′ lies between upper boundary δ₃ and lower boundary δ₄ and slope m_{b} of line b lies between upper boundary δ₅ and lower boundary δ₆; i.e., δ₄≧m_{a′}≧δ₃ and δ₆≧m_{b}≧δ₅. In some embodiments, 40 MPa/μm≦m_{a′}≦200 MPa/μm, and 2 MPa/μm≦m_{b}≦8 MPa/μm. In some embodiments, 40 MPa/μm≦m_{a′}≦120 MPa/μm and, in some embodiments, 50 MPa/μm≦m_{a′}≦120 MPa/μm.

Compressive stress CS and depth of the compressive layer DOL are measured using those means known in the art. Such means include, but are not limited to, measurement of surface stress (FSM) using commercially available instruments such as the FSM-6000, manufactured by Luceo Co., Ltd. (Tokyo, Japan), or the like, and methods of measuring compressive stress and depth of layer are described in ASTM 1422C-99, entitled “Standard Specification for Chemically Strengthened Flat Glass,” and ASTM 1279.19779 “Standard Test Method for Non-Destructive Photoelastic Measurement of Edge and Surface Stresses in Annealed, Heat-Strengthened, and Fully-Tempered Flat Glass,” the contents of which are incorporated herein by reference in their entirety. Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2008), entitled “Standard Test Method for Measurement of Glass Stress-Optical Coefficient,” the contents of which are incorporated herein by reference in their entirety, and a bulk cylinder method.

The relationship between CS and central tension CT may, in some embodiments, be approximated by the expression:

CT=(CS·DOL)/(t−2DOL) (8),

where t is the thickness, expressed in microns (μm), of the glass article. In various sections of the disclosure, central tension CT and compressive stress CS are expressed herein in megaPascals (MPa), thickness t is expressed in either microns (μm) or millimeters (mm), and depth of layer DOL is expressed in microns (μm) or millimeters (mm), consistent with the representation of t.

For strengthened glass articles in which the compressive stress layers extend to deeper depths within the glass, the FSM technique may suffer from contrast issues which affect the observed DOL value. At deeper DOL values, there may be inadequate contrast between the TE and TM spectra, thus making the calculation of the difference between TE and TM spectra—and determining the DOL—more difficult. Moreover, the FSM software analysis is incapable of determining the compressive stress profile (i.e., the variation of compressive stress as a function of depth within the glass). In addition, the FSM technique is incapable of determining the depth of layer resulting from the ion exchange of certain elements such as, for example, ion exchange of sodium for lithium.

The techniques described below have been developed to yield more accurately determine the depth of compression (DOC) and compressive stress profiles for strengthened glass articles.

In U.S. patent application Ser. No. 13/463,322, entitled “Systems And Methods for Measuring the Stress Profile of Ion-Exchanged Glass (hereinafter referred to as “Roussev I”),” filed by Rostislav V. Roussev et al. on May 3, 2012, and claiming priority to U.S. Provisional Patent Application No. 61/489,800, having the same title and filed on May 25, 2011, two methods for extracting detailed and precise stress profiles (stress as a function of depth) of tempered or chemically strengthened glass are disclosed. The spectra of bound optical modes for TM and TE polarization are collected via prism coupling techniques, and used in their entirety to obtain detailed and precise TM and TE refractive index profiles n_{TM}(z) and n_{TE}(z). The contents of the above applications are incorporated herein by reference in their entirety.

In one embodiment, the detailed index profiles are obtained from the mode spectra by using the inverse Wentzel-Kramers-Brillouin (IWKB) method.

In another embodiment, the detailed index profiles are obtained by fitting the measured mode spectra to numerically calculated spectra of pre-defined functional forms that describe the shapes of the index profiles and obtaining the parameters of the functional forms from the best fit. The detailed stress profile S(z) is calculated from the difference of the recovered TM and TE index profiles by using a known value of the stress-optic coefficient (SOC):

S(z)=[n_{TM}(z)−n_{TE}(z)]/SOC (9).

Due to the small value of the SOC, the birefringence n_{TM}(z)−n_{TE}(z) at any depth z is a small fraction (typically on the order of 1%) of either of the indices n_{TM}(z) and n_{TE}(z). Obtaining stress profiles that are not significantly distorted due to noise in the measured mode spectra requires determination of the mode effective indices with precision on the order of 0.00001 RIU. The methods disclosed in Roussev I further include techniques applied to the raw data to ensure such high precision for the measured mode indices, despite noise and/or poor contrast in the collected TE and TM mode spectra or images of the mode spectra. Such techniques include noise-averaging, filtering, and curve fitting to find the positions of the extremes corresponding to the modes with sub-pixel resolution.

Similarly, U.S. patent application Ser. No. 14/033,954, entitled “Systems and Methods for Measuring Birefringence in Glass and Glass-Ceramics (hereinafter “Roussev II”),” filed by Rostislav V. Roussev et al. on Sep. 23, 2013, and claiming priority to U.S. Provisional Application Ser. No. 61/706,891, having the same title and filed on Sep. 28, 2012, discloses apparatus and methods for optically measuring birefringence on the surface of glass and glass ceramics, including opaque glass and glass ceramics. Unlike Roussev I, in which discrete spectra of modes are identified, the methods disclosed in Roussev II rely on careful analysis of the angular intensity distribution for TM and TE light reflected by a prism-sample interface in a prism-coupling configuration of measurements. The contents of the above applications are incorporated herein by reference in their entirety.

In another disclosed method, derivatives of the TM and TE signals are determined after application of some combination of the aforementioned signal conditioning techniques. The locations of the maximum derivatives of the TM and TE signals are obtained with sub-pixel resolution, and the surface birefringence is proportional to the spacing of the above two maxima, with a coefficient determined as before by the apparatus parameters.

Associated with the requirement for correct intensity extraction, the apparatus comprises several enhancements, such as using a light-scattering surface (static diffuser) in close proximity to or on the prism entrance surface to improve the angular uniformity of illumination, a moving diffuser for speckle reduction when the light source is coherent or partially coherent, and light-absorbing coatings on portions of the input and output facets of the prism and on the side facets of the prism, to reduce parasitic background which tends to distort the intensity signal. In addition, the apparatus may include an infrared light source to enable measurement of opaque materials.

Furthermore, Roussev II discloses a range of wavelengths and attenuation coefficients of the studied sample, where measurements are enabled by the described methods and apparatus enhancements. The range is defined by αₛλ<250πσₛ, where αₛ is the optical attenuation coefficient at measurement wavelength λ, and σₛ is the expected value of the stress to be measured with typically required precision for practical applications. This wide range allows measurements of practical importance to be obtained at wavelengths where the large optical attenuation renders previously existing measurement methods inapplicable. For example, Roussev II discloses successful measurements of stress-induced birefringence of opaque white glass-ceramic at a wavelength of 1550 nm, where the attenuation is greater than about 30 dB/mm.

While it is noted above that there are some issues with the FSM technique at deeper DOL values, FSM is still a beneficial conventional technique which may utilized with the understanding that an error range of up to +/−20% is possible at deeper DOL values. The terms “depth of layer” and “DOL” as used herein refer to DOL values computed using the FSM technique, whereas the terms “depth of compression” and “DOC” refer to depths of the compressive layer determined by the methods described in Roussev I & II.

As stated above, the glass articles may be chemically strengthened by ion exchange. In this process, ions at or near the surface of the glass are replaced by—or exchanged with—larger ions usually having the same valence or oxidation state. In those embodiments in which the glass article comprises, consists essentially of, or consists of an alkali aluminosilicate glass, ions in the surface layer of the glass and the larger ions are monovalent alkali metal cations, such as Na⁺ (when Li⁺ is present in the glass), K⁺, Rb⁺, and Cs⁺. Alternatively, monovalent cations in the surface layer may be replaced with monovalent cations other than alkali metal cations, such as Ag⁺ or the like.

Ion exchange processes are typically carried out by immersing a glass article in a molten salt bath containing the larger ions to be exchanged with the smaller ions in the glass. It will be appreciated by those skilled in the art that parameters for the ion exchange process, including, but not limited to, bath composition and temperature, immersion time, the number of immersions of the glass in a salt bath (or baths), use of multiple salt baths, additional steps such as annealing, washing, and the like, are generally determined by the composition of the glass and the desired depth of layer and compressive stress of the glass that result from the strengthening operation. By way of example, ion exchange of alkali metal-containing glasses may be achieved by immersion in at least one molten bath containing a salt such as, but not limited to, nitrates, sulfates, and chlorides of the larger alkali metal ion. The temperature of the molten salt bath typically is in a range from about 380° C. up to about 450° C., while immersion times range from about 15 minutes up to about 40 hours. However, temperatures and immersion times different from those described above may also be used.

In addition, non-limiting examples of ion exchange processes in which glass is immersed in multiple ion exchange baths, with washing and/or annealing steps between immersions, are described in U.S. Pat. No. 8,561,429, by Douglas C. Allan et al., issued on Oct. 22, 2013, entitled “Glass with Compressive Surface for Consumer Applications,” and claiming priority from U.S. Provisional Patent Application No. 61/079,995, filed Jul. 11, 2008, in which glass is strengthened by immersion in multiple, successive, ion exchange treatments in salt baths of different concentrations; and U.S. Pat. No. 8,312,739, by Christopher M. Lee et al., issued on Nov. 20, 2012, and entitled “Dual Stage Ion Exchange for Chemical Strengthening of Glass,” and claiming priority from U.S. Provisional Patent Application No. 61/084,398, filed Jul. 29, 2008, in which glass is strengthened by ion exchange in a first bath is diluted with an effluent ion, followed by immersion in a second bath having a smaller concentration of the effluent ion than the first bath. The contents of U.S. Pat. Nos. 8,561,429 and 8,312,739 are incorporated herein by reference in their entirety.

The compressive stress is created by chemically strengthening the glass article, for example, by the ion exchange processes previously described herein, in which a plurality of first metal ions in the outer region of the glass article is exchanged with a plurality of second metal ions so that the outer region comprises the plurality of the second metal ions. Each of the first metal ions has a first ionic radius and each of the second alkali metal ions has a second ionic radius. The second ionic radius is greater than the first ionic radius, and the presence of the larger second alkali metal ions in the outer region creates the compressive stress in the outer region.

At least one of the first metal ions and second metal ions are ions of an alkali metal. The first ions may be ions of lithium, sodium, potassium, and rubidium. The second metal ions may be ions of one of sodium, potassium, rubidium, and cesium, with the proviso that the second alkali metal ion has an ionic radius greater than the ionic radius than the first alkali metal ion.

In some embodiments, the glass is strengthened in a single ion exchange step to produce the compressive stress profile shown in FIG. 2. Typically, the glass is immersed in a molten salt bath containing a salt of the larger alkali metal cation. In some embodiments, the molten salt bath contains or consists essentially of salts of the larger alkali metal cation. However, small amounts—in some embodiments, less that about 10 wt %, in some embodiments, less than about 5 wt %, and, in other embodiments less than about 2 wt %—of salts of the smaller alkali metal cation may be present in the bath. In other embodiments, salts of the smaller alkali metal cation may comprise at least about 30 wt %, or at least about 40 wt %, or from about 40 wt % to about 75 wt % of the ion exchange bath. This single ion exchange process may take place at a temperature of at least about 400° C. and, in some embodiments, at least about 440° C., for a time sufficient to achieve the desired depth of compression DOC. In some embodiments, the single step ion exchange process may be conducted for at least eight hours, depending on the composition of the bath.

In another embodiment, the glass is strengthened in a two-step or dual ion exchange method to produce the compressive stress profile shown in FIG. 3. The first step of the process, the glass is ion exchanged in the first molten salt bath described above. After completion of the first ion exchange, the glass is immersed in a second ion exchange bath. The second ion exchange bath is different—i.e., separate from and, in some embodiments, having a different composition—from the first bath. In some embodiments, the second ion exchange bath contains only salts of the larger alkali metal cation, although, in some embodiments small amounts of the smaller alkali metal cation (e.g., ≦2 wt %; ≦3 wt %) may be present in the bath. in addition, the immersion time and temperature of the second ion exchange step may differ from those of the first ion exchange step. In some embodiments, the second ion exchange step is carried out at a temperature of at least about 350° C. and, in other embodiments, at least about 380° C. The duration of the second ion exchange step is sufficient to achieve the desired depth dₐ of the shallow segment, in some embodiments, may be 30 minutes or less. In other embodiments, the duration is 15 minutes or less and, in some embodiments, in a range from about 10 minutes to about 60 minutes.

The second ion exchange bath is different than the first ion exchange bath, because the second ion exchange step is directed to delivering a different concentration of the larger cation or, in some embodiments, a different cation altogether, to the alkali aluminosilicate glass article than the first ion exchange step. In one or more embodiments, the second ion exchange bath may comprise at least about 95% by weight of a potassium composition that delivers potassium ions to the alkali aluminosilicate glass article. In a specific embodiment, the second ion exchange bath may comprise from about 98% to about 99.5% by weight of the potassium composition. While it is possible that the second ion exchange bath only comprises at least one potassium salt, the second ion exchange bath may, in further embodiments, comprise 0-5% by weight, or about 0.5-2.5% by weight of at least one sodium salt, for example, NaNO₃. In an exemplary embodiment, the potassium salt is KNO₃. In further embodiments, the temperature of the second ion exchange step may be 380° C. or greater.

The purpose of the second ion exchange step is to form a “spike” increase the compressive stress in the region immediately adjacent to the surface of the glass article, as represented by portion a′ of the stress profile shown in FIG. 3.

The glass articles described herein may comprise or consist of any glass that is chemically strengthened by ion exchange. In some embodiments, the glass is an alkali aluminosilicate glass.

In one embodiment, the alkali aluminosilicate glass comprises or consists essentially of: at least one of alumina and boron oxide, and at least one of an alkali metal oxide and an alkali earth metal oxide, wherein −15 mol %≦(R₂O+R′O—Al₂O₃—ZrO₂)—B₂O₃≦4 mol %, where R is one of Li, Na, K, Rb, and Cs, and R′ is at least one of Mg, Ca, Sr, and Ba. In some embodiments, the alkali aluminosilicate glass comprises or consists essentially of: from about 62 mol % to about 70 mol. % SiO₂; from 0 mol % to about 18 mol % Al₂O₃; from 0 mol % to about 10 mol % B₂O₃; from 0 mol % to about 15 mol % Li₂O; from 0 mol % to about 20 mol % Na₂O; from 0 mol % to about 18 mol % K₂O; from 0 mol % to about 17 mol % MgO; from 0 mol % to about 18 mol % CaO; and from 0 mol % to about 5 mol % ZrO₂. In some embodiments, the glass comprises alumina and boron oxide and at least one alkali metal oxide, wherein −15 mol %≦(R₂O+R′O—Al₂O₃—ZrO₂)—B₂O₃≦4 mol %, where R is at least one of Li, Na, K, Rb, and Cs, and R′ is at least one of Mg, Ca, Sr, and Ba; wherein 10≦Al₂O₃+B₂O₃+ZrO₂≦30 and 14≦R₂O+R′O≦25; wherein the silicate glass comprises or consists essentially of: 62-70 mol. % SiO₂; 0-18 mol % Al₂O₃; 0-10 mol % B₂O₃; 0-15 mol % Li₂O; 6-14 mol % Na₂O; 0-18 mol % K₂O; 0-17 mol % MgO; 0-18 mol % CaO; and 0-5 mol % ZrO₂. The glass is described in U.S. patent application Ser. No. 12/277,573 filed Nov. 25, 2008, by Matthew J. Dejneka et al., and entitled “Glasses Having Improved Toughness And Scratch Resistance,” and U.S. Pat. No. 8,652,978 filed Aug. 17, 2012, by Matthew J. Dejneka et al., and entitled “Glasses Having Improved Toughness And Scratch Resistance,” both claiming priority to U.S. Provisional Patent Application No. 61/004,677, filed on Nov. 29, 2008. The contents of all of the above are incorporated herein by reference in their entirety.

In another embodiment, the alkali aluminosilicate glass comprises or consists essentially of: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %. In some embodiments, the alkali aluminosilicate glass comprises or consists essentially of: 60-70 mol % SiO₂; 6-14 mol % Al₂O₃; 0-3 mol % B₂O₃; 0-1 mol % Li₂O; 8-18 mol % Na₂O; 0-5 mol % K₂O; 0-2.5 mol % CaO; above 0 to 3 mol % ZrO₂; 0-1 mol % SnO₂; and 0-1 mol % CeO₂, wherein 12 mol %<Li₂O+Na₂O+K₂O≦20 mol %, and wherein the silicate glass comprises less than 50 ppm As₂O₃. In some embodiments, the alkali aluminosilicate glass comprises or consists essentially of: 60-72 mol % SiO₂; 6-14 mol % Al₂O₃; 0-3 mol % B₂O₃; 0-1 mol % Li₂O; 0-20 mol % Na₂O; 0-10 mol % K₂O; 0-2.5 mol % CaO; 0-5 mol % ZrO₂; 0-1 mol % SnO₂; and 0-1 mol % CeO₂, wherein 12 mol %≦Li₂O+Na₂O+K₂O≦20 mol %, and wherein the silicate glass comprises less than 50 ppm As₂O₃ and less than 50 ppm Sb₂O₃. The glass is described in U.S. Pat. No. 8,158,543 by Sinue Gomez et al., entitled “Fining Agents for Silicate Glasses,” filed on Feb. 25, 2009; U.S. Pat. No. 8,431,502 by Sinue Gomez et al., entitled “Silicate Glasses Having Low Seed Concentration,” filed Jun. 13, 2012; and U.S. Pat. No. 8,623,776, by Sinue Gomez et al., entitled “Silicate Glasses Having Low Seed Concentration,” filed Jun. 19, 2013, all of which claim priority to U.S. Provisional Patent Application No. 61/067,130, filed on Feb. 26, 2008. The contents of all of the above are incorporated herein by reference in their entirety.

In another embodiment, the alkali aluminosilicate glass comprises SiO₂ and Na₂O, wherein the glass has a temperature T₃₅ₖₚ at which the glass has a viscosity of 35 kilo poise (kpoise), wherein the temperature T_{breakdown} at which zircon breaks down to form ZrO₂ and SiO₂ is greater than T₃₅ₖₚ. In some embodiments, the alkali aluminosilicate glass comprises or consists essentially of: from about 61 mol % to about 75 mol % SiO₂; from about 7 mol % to about 15 mol % Al₂O₃; from 0 mol % to about 12 mol % B₂O₃; from about 9 mol % to about 21 mol % Na₂O; from 0 mol % to about 4 mol % K₂O; from 0 mol % to about 7 mol % MgO; and 0 mol % to about 3 mol % CaO. The glass is described in U.S. patent application Ser. No. 12/856,840 by Matthew J. Dejneka et al., entitled “Zircon Compatible Glasses for Down Draw,” filed Aug. 10, 2010, and claiming priority to U.S. Provisional Patent Application No. 61/235,762, filed on Aug. 29, 2009. The contents of the above are incorporated herein by reference in their entirety.

In another embodiment, the alkali aluminosilicate glass comprises at least 50 mol % SiO₂ and at least one modifier selected from the group consisting of alkali metal oxides and alkaline earth metal oxides, wherein [(Al₂O₃ (mol %)+B₂O₃(mol %))/(Σ alkali metal modifiers (mol %))]>1. In some embodiments, the alkali aluminosilicate glass comprises or consists essentially of: from 50 mol % to about 72 mol % SiO₂; from about 9 mol % to about 17 mol % Al₂O₃; from about 2 mol % to about 12 mol % B₂O₃; from about 8 mol % to about 16 mol % Na₂O; and from 0 mol % to about 4 mol % K₂O. In some embodiments, the glass comprises or consists essentially of: at least 58 mol % SiO₂; at least 8 mol % Na₂O; from 5.5 to 12 mol % B₂O₃; and Al₂O₃, wherein [(Al₂O₃ (mol %)+B₂O₃(mol %))/(Σ alkali metal modifiers (mol %))]>1, Al₂O₃(mol %)>B₂O₃(mol %), 0.9<R₂O/Al₂O₃<1.3. The glass is described in U.S. Pat. No. 8,586,492, entitled “Crack And Scratch Resistant Glass and Enclosures Made Therefrom,” filed Aug. 18, 2010, by Kristen L. Barefoot et al., U.S. patent application Ser. No. 14/082,847, entitled “Crack And Scratch Resistant Glass and Enclosures Made Therefrom,” filed Nov. 18, 2013, by Kristen L. Barefoot et al., both claiming priority to U.S. Provisional Patent Application No. 61/235,767, filed on Aug. 21, 2009. The contents of all of the above are incorporated herein by reference in their entirety.

In another embodiment, the alkali aluminosilicate glass comprises SiO₂, Al₂O₃, P₂O₅, and at least one alkali metal oxide (R₂O), wherein 0.75≦[(P₂O₅(mol %)+R₂O(mol %))/M₂O₃ (mol %)]≦1.2, where M₂O₃═Al₂O₃+B₂O₃. In some embodiments, the alkali aluminosilicate glass comprises or consists essentially of: from about 40 mol % to about 70 mol % SiO₂; from 0 mol % to about 28 mol % B₂O₃; from 0 mol % to about 28 mol % Al₂O₃; from about 1 mol % to about 14 mol % P₂O₅; and from about 12 mol % to about 16 mol % R₂O; and, in certain embodiments, from about 40 to about 64 mol % SiO₂; from 0 mol % to about 8 mol % B₂O₃; from about 16 mol % to about 28 mol % Al₂O₃; from about 2 mol % to about 12% P₂O₅; and from about 12 mol % to about 16 mol % R₂O. The glass is described in U.S. patent application Ser. No. 13/305,271 by Dana C. Bookbinder et al., entitled “Ion Exchangeable Glass with Deep Compressive Layer and High Damage Threshold,” filed Nov. 28, 2011, and claiming priority to U.S. Provisional Patent Application No. 61/417,941, filed Nov. 30, 2010. The contents of all of the above are incorporated herein by reference in their entirety.

In still another embodiment, the alkali aluminosilicate glass comprises at least about 50 mol % SiO₂ and at least about 11 mol % Na₂O, and the compressive stress is at least about 900 MPa. In some embodiments, the glass further comprises Al₂O₃ and at least one of B₂O₃, K₂O, MgO and ZnO, wherein −340+27.1.Al₂O₃−28.7.B₂O₃+15.6.Na₂O−61.4.K₂O+8.1.(MgO+ZnO)≧0 mol %. In particular embodiments, the glass comprises or consists essentially of: from about 7 mol % to about 26 mol % Al₂O₃; from 0 mol % to about 9 mol % B₂O₃; from about 11 mol % to about 25 mol % Na₂O; from 0 mol % to about 2.5 mol % K₂O; from 0 mol % to about 8.5 mol % MgO; and from 0 mol % to about 1.5 mol % CaO. The glass is described in U.S. patent application Ser. No. 13/533,298, by Matthew J. Dejneka et al., entitled “Ion Exchangeable Glass with High Compressive Stress,” filed Jun. 26, 2012, and claiming priority to U.S. Provisional Patent Application No. 61/503,734, filed Jul. 1, 2011. The contents of all of the above are incorporated herein by reference in their entirety.

In other embodiments, the alkali aluminosilicate glass is ion exchangeable and comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %. In some embodiments, the glass comprises: at least about 50 mol % SiO₂; at least about 10 mol % R₂O, wherein R₂O comprises Na₂O; Al₂O₃, wherein Al₂O₃(mol %)<R₂O(mol %); and 3-4.5 mol % B₂O₃, wherein B₂O₃(mol %)—(R₂O(mol %)—Al₂O₃(mol %))≧3 mol %. In certain embodiments, the glass comprises or consists essentially of: at least about 50 mol % SiO₂; from about 9 mol % to about 22 mol % Al₂O₃; from about 3 mol % to about 10 mol % B₂O₃; from about 9 mol % to about 20 mol % Na₂O; from 0 mol % to about 5 mol % K₂O; at least about 0.1 mol % MgO, ZnO, or combinations thereof, wherein 0≦MgO≦6 and 0≦ZnO≦6 mol %; and, optionally, at least one of CaO, BaO, and SrO, wherein 0 mol %≦CaO+SrO+BaO≦2 mol %. When ion exchanged, the glass, in some embodiments, has a Vickers crack initiation threshold of at least about 10 kgf. Such glasses are described in U.S. patent application Ser. No. 14/197,658, filed May 28, 2013, by Matthew J. Dejneka et al., entitled “Zircon Compatible, Ion Exchangeable Glass with High Damage Resistance,” which is a continuation of U.S. patent application Ser. No. 13/903,433, filed May 28, 2013, by Matthew J. Dejneka et al., entitled “Zircon Compatible, Ion Exchangeable Glass with High Damage Resistance,” both claiming priority to Provisional Patent Application No. 61/653,489, filed May 31, 2012. The contents of these applications are incorporated herein by reference in their entirety.

In some embodiments, the glass comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, and wherein B₂O₃(mol %)—(R₂O(mol %)—Al₂O₃(mol %))≧4.5 mol %. In other embodiments, the glass has a zircon breakdown temperature that is equal to the temperature at which the glass has a viscosity of greater than about 40 kPoise and comprises: at least about 50 mol % SiO₂; at least about 10 mol % R₂O, wherein R₂O comprises Na₂O; Al₂O₃; and B₂O₃, wherein B₂O₃(mol %)—(R₂O(mol %)—Al₂O₃(mol %))≧4.5 mol %. In still other embodiments, the glass is ion exchanged, has a Vickers crack initiation threshold of at least about 30 kgf, and comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, wherein B₂O₃(mol %)—(R₂O(mol %)—Al₂O₃(mol %))≧4.5 mol %. Such glasses are described in U.S. Pat. No. 903,398, by Matthew J. Dejneka et al., entitled “Ion Exchangeable Glass with High Damage Resistance,” filed May 28, 2013, claiming priority from U.S. Provisional Patent Application No. 61/653,485, filed May 31, 2012. The contents of these applications are incorporated by reference herein in their entirety.

In certain embodiments, the alkali aluminosilicate glass comprises at least about 4 mol % P₂O₅, wherein (M₂O₃(mol %)/RₓO(mol %))<1, wherein M₂O₃═Al₂O₃+B₂O₃, and wherein RₓO is the sum of monovalent and divalent cation oxides present in the alkali aluminosilicate glass. In some embodiments, the monovalent and divalent cation oxides are selected from the group consisting of Li₂O, Na₂O, K₂O, Rb₂O, Cs₂O, MgO, CaO, SrO, BaO, and ZnO. In some embodiments, the glass comprises 0 mol % B₂O₃. In some embodiments, the glass is ion exchanged to a depth of layer of at least about 10 μm and comprises at least about 4 mol % P₂O₅, wherein 0.6<[M₂O₃(mol %)/RₓO(mol %)]<1.4; or 1.3<[(P₂O₅+R₂O)/M₂O₃]≦2.3; where M₂O₃═Al₂O₃+B₂O₃, RₓO is the sum of monovalent and divalent cation oxides present in the alkali aluminosilicate glass, and R₂O is the sum of divalent cation oxides present in the alkali aluminosilicate glass. The glass is described in U.S. patent application Ser. No. 13/678,013 by Timothy M. Gross, entitled “Ion Exchangeable Glass with High Crack Initiation Threshold,” filed Nov. 15, 2012, and U.S. patent application Ser. No. 13/677,805 by Timothy M. Gross, entitled “Ion Exchangeable Glass with High Crack Initiation Threshold,” filed Nov. 15, 2012, both claiming priority to U.S. Provisional Patent Application No. 61/560,434 filed Nov. 16, 2011. The contents of these applications are incorporated herein by reference in their entirety.

In other embodiments, the alkali aluminosilicate glass comprises: from about 50 mol % to about 72 mol % SiO₂; from about 12 mol % to about 22 mol % Al₂O₃; up to about 15 mol % B₂O₃; up to about 1 mol % P₂O₅; from about 11 mol % to about 21 mol % Na₂O; up to about 5 mol % K₂O; up to about 4 mol % MgO; up to about 5 mol % ZnO; and up to about 2 mol % CaO. In some embodiments, the glass comprises: from about 55 mol % to about 62 mol % SiO₂; from about 16 mol % to about 20 mol % Al₂O₃; from about 4 mol % to about 10 mol % B₂O₃; from about 14 mol % to about 18 mol % Na₂O; from about 0.2 mol % to about 4 mol % K₂O; up to about 0.5 mol % MgO; up to about 0.5 mol % ZnO; and up to about 0.5 mol % CaO, wherein the glass is substantially free of P₂O₅. In some embodiments, Na₂O+K₂O—Al₂O₃≦2.0 mol % and, in certain embodiments Na₂O+K₂O—Al₂O₃≦0.5 mol %. In some embodiments, B₂O₃—(Na₂O+K₂O—Al₂O₃)>4 mol % and, in certain embodiments, B₂O₃—(Na₂O+K₂O—Al₂O₃)>1 mol %. In some embodiments, 24 mol %≦RAlO₄≦45 mol %, and, in other embodiments, 28 mol %≦RAlO₄≦45 mol %, where R is at least one of Na, K, and Ag. The glass is described in U.S. Provisional Patent Application No. 61/909,049 by Matthew J. Dejneka et al., entitled “Fast Ion Exchangeable Glasses with High Indentation Threshold,” filed Nov. 26, 2013, the contents of which are incorporated herein by reference in their entirety.

In some embodiments, the glasses described herein are substantially free of at least one of arsenic, antimony, barium, strontium, bismuth, lithium, and their compounds. In other embodiments, the glasses may include up to about 0.5 mol % Li₂O, or up to about 5 mol % Li₂O or, in some embodiments, up to about 10 mol % Li₂O.

In some embodiments, the glasses described herein, when ion exchanged, are resistant to introduction of flaws by sharp or sudden impact. Accordingly, these ion exchanged glasses exhibit Vickers crack initiation threshold of at least about 10 kilogram force (kgf). In certain embodiments, these glasses exhibit a Vickers crack initiation threshold of at least 20 kgf and, in some embodiments, at least about 30 kgf.

The glasses described herein may, in some embodiments, be down-drawable by processes known in the art, such as slot-drawing, fusion drawing, re-drawing, and the like, and have a liquidus viscosity of at least 130 kilopoise. In addition to those compositions listed hereinabove, various other ion exchangeable alkali aluminosilicate glass compositions may be used.

The strengthened glasses described herein are considered suitable for various two- and three-dimensional shapes and may be utilized in various applications, and various thicknesses are contemplated herein. In some embodiments, the glass article has a thickness in a range from about 0.1 mm up to about 1.5 mm. In some embodiments, the glass article has a thickness in a range from about 0.1 mm up to about 1.0 mm and, in certain embodiments, from about 0.1 mm up to about 0.5 mm.

Strengthened glass articles may also be defined by their central tension. In one or more embodiments, the strengthened glass article has a CT≦150 MPa, or a CT≦125 MPa, or CT≦100 MPa. The central tension of the strengthened glass correlates to the frangible behavior of the strengthened glass article.

In another aspect, a method of making a strengthened glass article having at least one compressive stress layer extending from a surface of the strengthened glass article to a depth of compression DOC of at least about 45 μm is provided. The method includes a first ion exchange step in which an alkali aluminosilicate glass article is immersed in a first ion exchange bath at a temperature of greater than 400° C. for a time sufficient such that the compressive stress layer has a depth of compression of at least about 45 μm after the first ion exchange step. In some embodiments, it is preferable that the depth of compression achieved after the first step be at least 50 μm. Even more preferable are compression depths DOC greater than 55 μm, or even 60 μm, particularly if the thickness of the glass exceeds 0.5 mm.

Actual immersion times in the first ion exchange bath may depend upon factors such as the temperature and/or composition of the ion exchange bath, the diffusivity of the cations within the glass, and the like. Accordingly, various time periods for ion exchange are contemplated as being suitable. In those instances in which potassium cations from the ion exchange bath are exchanged for sodium cations in the glass, the bath typically comprises potassium nitrate (KNO₃). Here, the first ion exchange step, in some embodiments, may be conducted for a time of at least 5 hours. Longer ion exchange periods for the first ion exchange step may correlate with larger sodium ion content in the first ion exchange bath. The desired sodium ion content in first ion exchange bath may be achieved, for example, by including at least about 30% by weight or, in some embodiments, at least about 40% by weight of a sodium compound such as sodium nitrate (NaNO₃) or the like in the first ion exchange bath. In some embodiments, the sodium compound accounts for about 40% to about 60% by weight of the first ion exchange bath. In an exemplary embodiment, the first ion exchange step is carried out at a temperature of about 440° C. or greater.

After the first ion exchange step is performed, the strengthened glass article may have a maximum compressive stress (CS) of at least 150 MPa. In further embodiments, the strengthened glass article may have a CS of at least 200 MPa after the first ion exchange step, or a CS range of about 200 to about 300 MPa after the first ion exchange step. While the first ion exchange step minimally achieves a compressive layer depth/depth of compression DOC of at least 45 μm, it is contemplated that the compressive stress layer may have a depth of 50 μm to 100 μm and, in some embodiments, 60 μm to 100 μm after the first ion exchange step.

Following the first ion exchange step, a second ion exchange step may be conducted by immersing the alkali aluminosilicate glass article in a second ion exchange bath different from the first ion exchange bath at a temperature of at least 350° C. for a time sufficient to produce the shallow steep segment with a depth dₐ of at least about 3 μm.

The second ion exchange step is a relatively rapid ion exchange step that yields a “spike” of compressive stress near the surface of the glass as depicted in FIG. 3. In one or more embodiments, the second ion exchange step may be conducted for a time of up to about 30 minutes or, in other embodiments, up to about 15 minutes or, in some embodiments, in a range from about 10 minutes to about 60 minutes.

The second ion exchange step is directed to delivering a different ion to the alkali aluminosilicate glass article than the first ion exchange step. The composition of the second ion exchange bath therefore differs from the first ion exchange bath. In some embodiments, the second ion exchange bath comprises at least about 95% by weight of a potassium composition (e.g., KNO₃) that delivers potassium ions to the alkali aluminosilicate glass article. In a specific embodiment, the second ion exchange bath may comprise from about 98% to about 99.5% by weight of the potassium composition. While it is possible that the second ion exchange bath only comprises a potassium composition, the second ion exchange bath may, in further embodiments, comprise up to about 2% by weight, or from about 0.5% to about 1.5% by weight of a sodium composition such as, for example, NaNO₃. In further embodiments, the temperature of the second ion exchange step may be 390° C. or greater.

In some embodiments, the second ion exchange step may conclude the chemical strengthening procedure. The strengthened glass article may have a compressive stress (CS) of at least about 700 MPa following the second ion exchange step. In a further embodiment, the strengthened glass article has a maximum compressive stress of about 700 to about 1200 MPa, or about 700 to 1000 MPa after the second ion exchange step. While the second ion exchange step minimally achieves a compressive layer DOL of at least about 70 μm, it is contemplated that the compressive stress layer may have a DOL in a range from about 90 μm to about 130 μm after the second ion exchange step.

Frangible behavior is characterized by at least one of: breaking of the strengthened glass article (e.g., a plate or sheet) into multiple small pieces (e.g., ≦1 mm); the number of fragments formed per unit area of the glass article; multiple crack branching from an initial crack in the glass article; violent ejection of at least one fragment a specified distance (e.g., about 5 cm, or about 2 inches) from its original location; and combinations of any of the foregoing breaking (size and density), cracking, and ejecting behaviors. As used herein, the terms “frangible behavior” and “frangibility” refer to those modes of violent or energetic fragmentation of a strengthened glass article absent any external restraints, such as coatings, adhesive layers, or the like. While coatings, adhesive layers, and the like may be used in conjunction with the strengthened glass articles described herein, such external restraints are not used in determining the frangibility or frangible behavior of the glass articles.

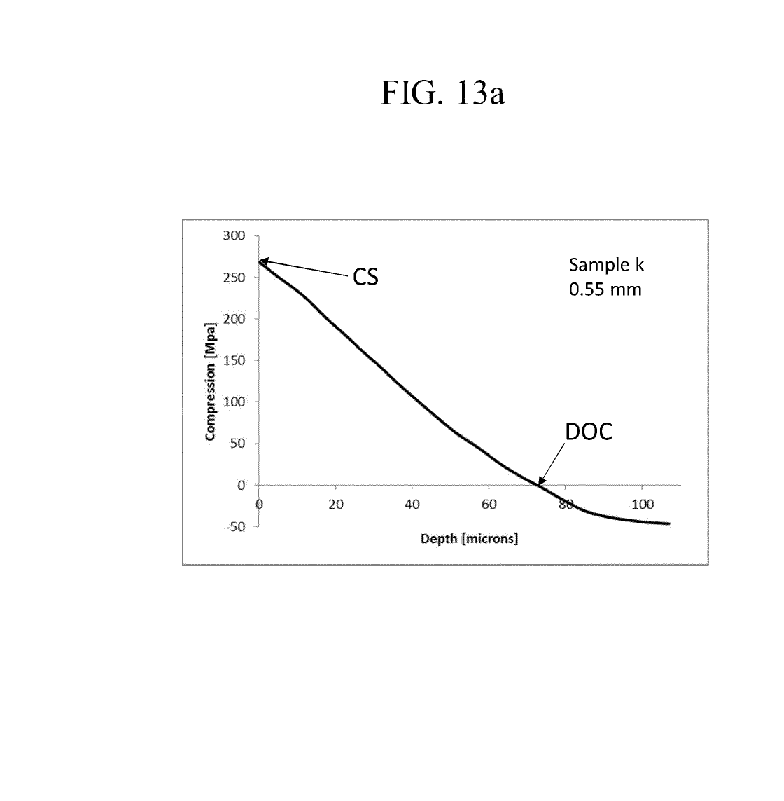

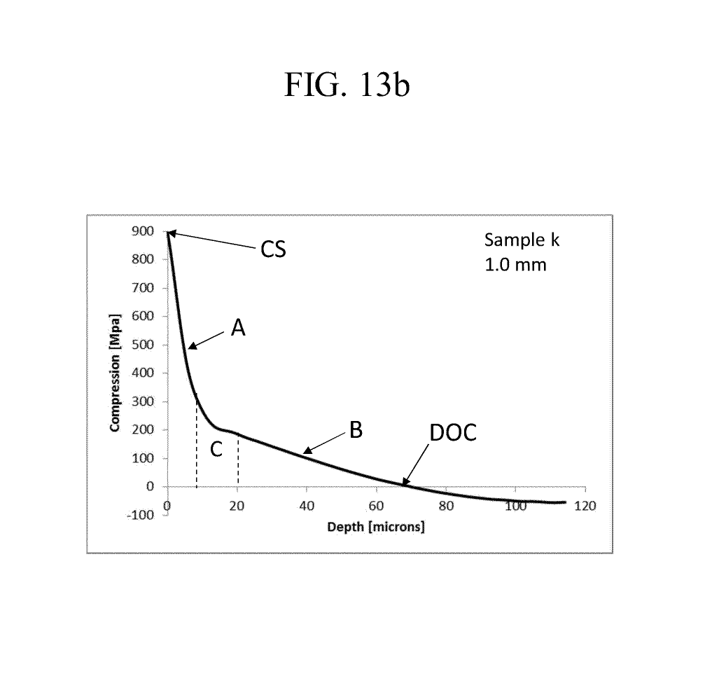

Examples of frangible behavior and non-frangible behavior of strengthened glass articles upon point impact with a sharp indenter are shown in FIGS. 13a and 13b. The point impact test that is used to determine frangible behavior includes an apparatus that is delivered to the surface of the glass article with a force that is just sufficient to release the internally stored energy present within the strengthened glass article. That is, the point impact force is sufficient to create at least one new crack at the surface of the strengthened glass sheet and extend the crack through the compressive stress CS region (i.e., depth of layer) into the region that is under central tension CT. The impact energy needed to create or activate the crack in a strengthened glass sheet depends upon the compressive stress CS and depth of layer DOL of the article, and thus upon the conditions under which the sheet was strengthened (i.e., the conditions used to strengthen a glass by ion exchange). Otherwise, each ion exchanged glass plate shown in FIGS. 13a and 13b was subjected to a sharp dart indenter (e.g., a SiC indenter) contact sufficient to propagate a crack into the inner region of the plate, the inner region being under tensile stress. The force applied to the glass plate was just sufficient to reach the beginning of the inner region, thus allowing the energy that drives the crack to come from the tensile stresses in the inner region rather than from the force of the dart impact on the outer surface. The degree of ejection may be determined, for example, by centering the glass sample on a grid, impacting the sample and measuring the ejection distance of individual pieces using the grid.

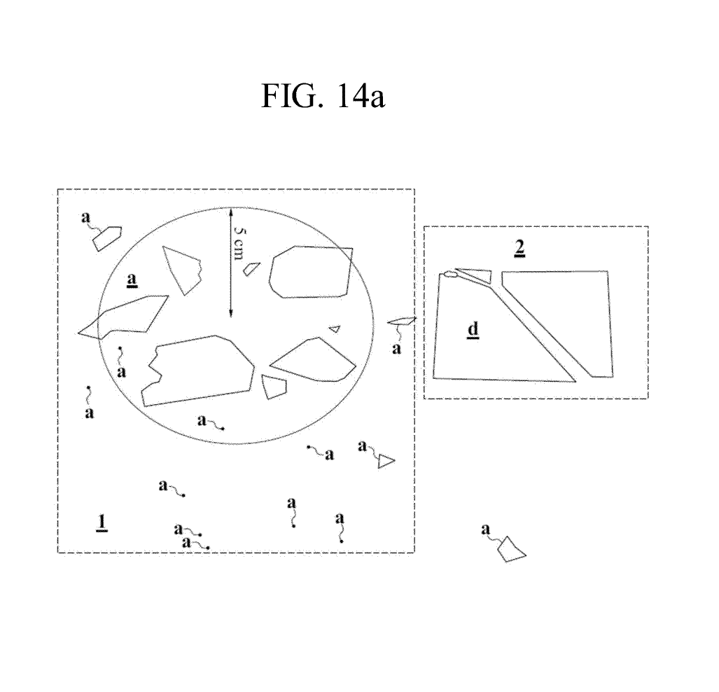

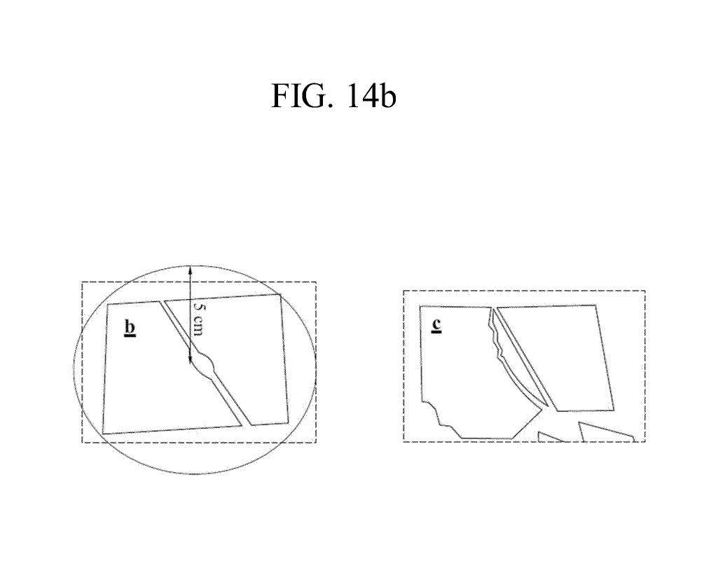

Referring to FIG. 14a, glass plate a can be classified as being frangible. In particular, glass plate a fragmented into multiple small pieces that were ejected, and exhibited a large degree of crack branching from the initial crack to produce the small pieces. Approximately 50% of the fragments are less than 1 mm in size, and it is estimated that about 8 to 10 cracks branched from the initial crack. Glass pieces were also ejected about 5 cm from original glass plate a, as seen in FIG. 14a. A glass article that exhibits any of the three criteria (i.e., multiple crack branching, ejection, and extreme fragmentation) described hereinabove is classified as being frangible. For example, if a glass exhibits excessive branching alone but does not exhibit ejection or extreme fragmentation as described above, the glass is still characterized as frangible.

Glass plates b, c, (FIG. 14b) and d (FIG. 14a) are classified as not frangible. In each of these samples, the glass sheet has broken into a small number of large pieces. Glass plate b (FIG. 14), for example, has broken into two large pieces with no crack branching; glass plate c (FIG. 14b) has broken into four pieces with two cracks branching from the initial crack; and glass plate d (FIG. 14a) has broken into four pieces with two cracks branching from the initial crack. Based on the absence of ejected fragments (i.e., no glass pieces forcefully ejected more than 2 inches from their original location), no visible fragments ≦1 mm in size, and the minimal amount of observed crack branching, samples b, c, and d are classified as non-frangible or substantially non-frangible.

Based on the foregoing, a frangibility index (Table 1) can be constructed to quantify the degree of frangible or non-frangible behavior of a glass, glass ceramic, and/or a ceramic article upon impact with another object. Index numbers, ranging from 1 for non-frangible behavior to 5 for highly frangible behavior, have been assigned to describe different levels of frangibility or non-frangibility. Using the index, frangibility can be characterized in terms of numerous parameters: 1) the percentage of the population of fragments having a diameter (i.e., maximum dimension) of less than 1 mm (“Fragment size” in Table 1); 2) the number of fragments formed per unit area (in this instance, cm²) of the sample (“Fragment density” in Table 1); 3) the number of cracks branching from the initial crack formed upon impact (“Crack branching” in Table 1); and 4) the percentage of the population of fragments that is ejected upon impact more than about 5 cm (or about 2 inches) from their original position (“Ejection” in Table 1).

TABLE 1
Criteria for determining the degree of frangibility and
frangibility index.

| | | Fragment | Fragment | | |
|---|---|---|---|---|---|
| Degree of | Frangibility | size | density | Crack | Ejection |
| frangibility | index | (% ≦ 1 mm) | (fragments/cm²) | branching | (% ≧ 5 cm) |
| High | 5 | >20 | >7 | >9 | >6 |
| Medium | 4 | 10 < n ≦ 20 | 5 < n ≦ 7 | 7 < n ≦ 9 | 4 < n ≦ 6 |
| Low | 3 | 5 < n ≦ 10 | 3 < n ≦ 5 | 5 < n ≦ 7 | 2 < n ≦ 4 |
| None | 2 | 0 < n ≦ 5 | 1 < n ≦ 3 | 2 < n ≦ 5 | 0 < n ≦ 2 |
| | 1 | 0 | n ≦ 1 | n ≦ 2 | 0 |

A frangibility index is assigned to a glass article if the article meets at least one of the criteria associated with a particular index value. Alternatively, if a glass article meets criteria between two particular levels of frangibility, the article may be assigned a frangibility index range (e.g., a frangibility index of 2-3). The glass article may be assigned the highest value of frangibility index, as determined from the individual criteria listed in Table 1. In many instances, it is not possible to ascertain the values of each of the criteria, such as the fragmentation density or percentage of fragments ejected more than 5 cm from their original position, listed in Table 1. The different criteria are thus considered individual, alternative measures of frangible behavior and the frangibility index such that a glass article falling within one criteria level will be assigned the corresponding degree of frangibility and frangibility index. If the frangibility index based on any of the four criteria listed in Table 1 is 3 or greater, the glass article is classified as frangible.

Applying the foregoing frangibility index to the samples shown in FIGS. 13a and 13b, glass plate a fragmented into multiple ejected small pieces and exhibited a large degree of crack branching from the initial crack to produce the small pieces. Approximately 50% of the fragments are less than 1 mm in size and it is estimated that about 8 to 10 cracks branched from the initial crack. Based upon the criteria listed in Table 1, glass plate a has a frangibility index of between about 4-5, and is classified as having a medium-high degree of frangibility.

A glass article having a frangibility index of less than 3 (low frangibility) may be considered to be non-frangible or substantially non-frangible. Glass plates b, c, and d each lack fragments having a diameter of less than 1 mm, multiple branching from the initial crack formed upon impact and fragments ejected more than 5 cm from their original position. Glass plates b, c, and d are non-frangible and thus have a frangibility index of 1 (not frangible).

As previously discussed, the observed differences in behavior between glass plate a, which exhibited frangible behavior, and glass plates b, c, and d, which exhibited non-frangible behavior, in FIGS. 13a and 13b can be attributed to differences in central tension CT among the samples tested. The possibility of such frangible behavior is one consideration in designing various glass products, such as cover plates or windows for portable or mobile electronic devices such as cellular phones, entertainment devices, and the like, as well as for displays for information terminal (IT) devices, such as laptop computers. Moreover, the depth of the compression layer DOL and the maximum value of compressive stress CSs that can be designed into or provided to a glass article are limited by such frangible behavior.

Accordingly, the strengthened glass articles described herein, in some embodiments, exhibit a frangibility index of less than 3 when subjected to a point impact sufficient to break the strengthened glass article. In other embodiments, non-frangible strengthened glass articles may achieve a frangibility index less than 2 or less than 1.

The strengthened glass articles described herein demonstrate improved fracture resistance when subjected to repeated drop tests. While one of ordinary skill in the art may contemplate various experimental parameters for the drop test, the strengthened glass articles of the present disclosure are, in some embodiments, able to withstand fracture when dropped in a drop test from a height of at least 100 cm onto a drop surface or, in other embodiments, from a height of at least 150 cm, or in still other embodiments, from a height of at least 200 cm, or still other embodiments, from a height of 220 cm.

Further demonstrating the survivability of the glasses described herein, the strengthened glass is able to withstand fracture when the strengthened glass contacts the drop surface at a flat angle, at a non-flat angle, or both. As used herein, “flat angle” means 180° relative to the drop surface. Various angles relative to the drop surface are contemplated for the “non-flat angle.” In one non-limiting example, the non-flat angle is 30° relative to the drop surface. A dual axis inclinometer is typically used to ensure consistency and accuracy of the 180° and non-flat drop angles. In addition, the device sits on a fixed platform, which includes flat (180°) and 30° fixtures to ensure consistent sample loading in the drop tester jaws.

The drop surface is an abrasive surface configured to simulate damage that may result when an electronic device is dropped on “real world” surfaces such as, for example, asphalt. Surviving repeated drops onto the abrasive surface is an indication of better performance on asphalt, as well as other surfaces; e.g., concrete or granite.

Various materials are contemplated for use as the abrasive surface. In a one particular embodiment, the abrasive surface is sandpaper, such as silicon carbide (SiC) sandpaper, engineered sandpaper, or any abrasive material known to one ordinary skilled in the art for having comparable hardness and/or sharpness. In some embodiments, SiC sandpaper having 180 grit and an average particle size of about 80 μm may be used, as it has a known range of particle sharpness, a surface topography more consistent than concrete or asphalt, and a particle size and sharpness that produces the desired level of specimen surface damage. One non-limiting example of commercially available 180 grit sandpaper that may be used in the drop tests described herein is Rhynowet® 180 grit sandpaper produced by Indasa.

In the drop tests, the sandpaper may be replaced after each drop to avoid “aging” effects that have been observed in repeated use of concrete or asphalt drop surfaces. In addition to aging, different asphalt morphologies, temperatures, and/or humidity may affect the performance of the asphalt. Unlike concrete or asphalt, the sandpaper abrasive surface delivers a consistent amount of damage across all samples.

Various drop heights are typically used in the drop tests. The drop test may, for example, utilize a minimum drop height to start (e.g., about 10-20 cm). The height may then be increased for successive drops by either a set increment or variable increments. The drop test is stopped once the strengthened glass breaks. Alternatively, if the drop height reaches the maximum drop height (e.g., about 220 cm) without glass fracture, the drop test may also be stopped, or the strengthened glass article may be repeatedly dropped from that maximum height until fracture occurs.

The following description lists a detailed procedural framework that was used to perform sandpaper drop tests. For the drop tests, a Yoshida Seiki DT-205 Drop Test System is used. The system is oriented to fully contact—but not secured to—a painted concrete floor. The steel base plate is approximately ¾ inch (in) thick and stock rectangular polymer jaws with vertical parallel faces are utilized. The test devices are commercially available smartphones retrofitted with the strengthened cover glass described herein such that the glass sat “proud (i.e., above the bezel and not recessed in the frame of the phone)” of the bezel. Drop tests using as-manufactured phones confirmed that the drop tests described hereinabove are truly representative of damage incurred in normal use.

For drop surface preparation, two pieces (9 in×11 in) Rhynowet 180 grit sandpaper are typically used. To prevent lateral movement of the actual drop surface, a first piece is centered below the drop tester jaws and the back surface is fully adhered to the steel base plate of the drop tester with a thin layer of Scotch Spray Mount™ contact adhesive.

A second piece of sandpaper, which serves as the actual drop surface, is aligned to fully cover the above first piece, abrasive-side up, without adhesive being used. This piece was held in place with four strong, rare earth magnets in each corner. Each magnet is covered with a polymer fingertip cut from a cut-resistant glove to prevent contact damage to the cover glass if the device bounces to the side. A new second piece of sandpaper may be used for each test device.

The test device is loaded into the drop tester jaws with the cover glass facing downward and parallel to the plane of the sandpaper drop surface. To ensure smooth release, the jaws only contact the long edges of the drop test device and do not contact any buttons or other physical phone features that extend beyond the contact surface of the device edges. The test device edges are aligned to contact the vertical midpoints of the jaws, which are in turn centered on the jaw air piston actuators. This prevents creation of non-normal forces and protects against other forces that could be imparted to the test device.

The first drop is performed at a starting height of 20 cm, which represents the distance from the exposed surface of the cover glass to the top of the drop surface. If no cover glass failure occurs at this height, the drop height is increased by 10 cm, and the device is aligned within the jaws and dropped again. The test device is continually dropped at 10 cm increments until the cover glass fails or until the cover glass survives a maximum drop height; e.g., 220 cm.

For the next device drop in the test sequence, the magnets and used top piece of sandpaper are removed. The steel drop tester base plate and the bottom first piece of sandpaper are cleaned with a brush and then subjected to compressed air to remove loose contaminants, after which the above drop procedure is performed again.

### EXAMPLES

The following examples illustrate the features and advantages described herein and are no way intended to limit the disclosure and appended claims hereto.

### Compressive Stress Profiles

Using the methods described by Roussev I and Roussev II, referenced hereinabove, glass samples of various thicknesses were ion exchanged and their respective compressive stress profiles were determined. Spectra of bound optical modes for TM and TE polarization are collected via prism coupling techniques, and used in their entirety to obtain detailed and precise TM and TE refractive index profiles n_{TM}(z) and n_{TE}(z), and detailed index profiles are obtained by fitting the measured mode spectra to numerically calculated spectra of pre-defined functional forms that describe the shapes of the index profiles and obtaining the parameters of the functional forms from the best fit. The glass samples had compositions described in U.S. patent application Ser. No. 13/678,013 by Timothy M. Gross. Samples having thicknesses of 0.4 mm, 0.5 mm, 0.7 mm, 0.8 mm, and 1.0 mm were studied. The results of these ion exchange studies are summarized in Table 2.

TABLE 2
Results of ion exchange studies. IOX₁ and IOX₂ refer to
the first and second ion exchange steps, respectively.

| | Thickness (mm) | | | | |
|---|---|---|---|---|---|
| | 0.4 | 0.4 | 0.4 | 0.5 | 0.5 |
| | Sample | | | | |
| | a | b | c | d | e |
| IOX₁ | | | | | |
| Time (hr) | 9 | 10 | 11.25 | 5.8 | 8.3 |
| T (° C.) | 441 | 441 | 441 | 440 | 440 |
| Wt % | 52/48 | 52/48 | 52/48 | 37/63 | 52/48 |
| NaNO₃/KNO₃ | | | | | |
| DOC (μm) | 63 | 65 | 67 | 61 | 66 |
| CS (MPa) | 232 | 232 | 227 | 329? | 243 |
| Slope A | | | 3.4 | | |
| (MPa/μm) | | | | | |
| IOX₂ | | | | | |
| Time (min) | | 12 | | | |
| T (° C.) | | 390 | | | |
| Wt % | | 1/99 | | | |
| NaNO₃/KNO₃ | | | | | |
| DOC (μm) | | 61 | | | |
| CS (MPa) | | 846 | | | |
| Slope A | | 3.5 | | | |
| (MPa/μm) | | | | | |
| Slope B | | 85 | | | |
| (MPa/μm) | | | | | |
| Transition | | 8-16 | | | |
| region (μm) | | | | | |

| | Thickness (mm) | | | | |
|---|---|---|---|---|---|
| | 0.55 | 0.7 | 0.8 | 0.8 | 0.8 |
| | Sample | | | | |
| | k | f | g | h | l |
| IOX₁ | | | | | |
| Time (hr) | 7.75 | 8.5 | 8.8 | 8.8 | 48 |
| T (° C.) | 450 | 450 | 440 | 440 | 450 |
| Wt % | 40/60 | 45/55 | 37/63 | 37/63 | 69/31 |
| NaNO₃/KNO₃ | | | | | |
| DOC (μm) | 73 | 75 | 72 | 72 | 142 |
| CS (MPa) | 268 | 281 | 358 | 358 | 146 |
| Slope A | 3.7 | 3.75 | 5.1 | 5.1 | 1.03 |
| (MPa/μm) | | | | | |
| IOX₂ | | | | | |
| Time (min) | 12 | 12 | 12 | 24 | |
| T (° C.) | 390 | 390 | 390 | 390 | |
| Wt % | 0.5/99.5 | 1/99 | 1/99 | 1/99 | |
| NaNO₃/KNO₃ | | | | | |
| DOC (μm) | 70 | 72 | 70 | 70 | |
| CS (MPa) | 896 | 842 | 861 | 877 | |
| Slope A | 3.7 | 3.75 | 4.65 | 5 | |
| (MPa/μm) | | | | | |
| Slope B | 86 | 85 | 78 | 52 | |
| (MPa/μm) | | | | | |
| Transition | 8-16 | 7-15 | 7-12 | 8-15 | |
| region C (μm) | | | | | |

| | Thickness (mm) | | |
|---|---|---|---|
| | 0.8 | 0.9 | 1.0 |
| | Sample | | |
| | m | i | j |
| IOX₁ | | | |
| Time (hr) | 65 | 7.5 | 11 |
| T (° C.) | 450 | 450 | 440 |
| Wt % | 69/31 | 38/62 | 37/63 |
| NaNO₃/KNO₃ | | | |
| DOC (μm) | 153 | | 82 |
| CS (MPa) | 140 | | 359 |
| Slope A | 0.92 | | 5.3 |
| (MPa/μm) | | | |
| IOX₂ | | | |
| Time (min) | | 18 | 12 |
| T (° C.) | | 390 | 390 |
| Wt % | | 2/98 | 1/99 |
| NaNO₃/KNO₃ | | | |
| DOC (μm) | | 73 | 80 |
| CS (MPa) | | 746 | 860 |
| Slope A | | 4 | 5.3 |
| (MPa/μm) | | | |
| Slope B | | 52 | 73 |
| (MPa/μm) | | | |
| Transition | | | 8-16 |
| region C (μm) | | | |

### i) 0.4 mm Thickness

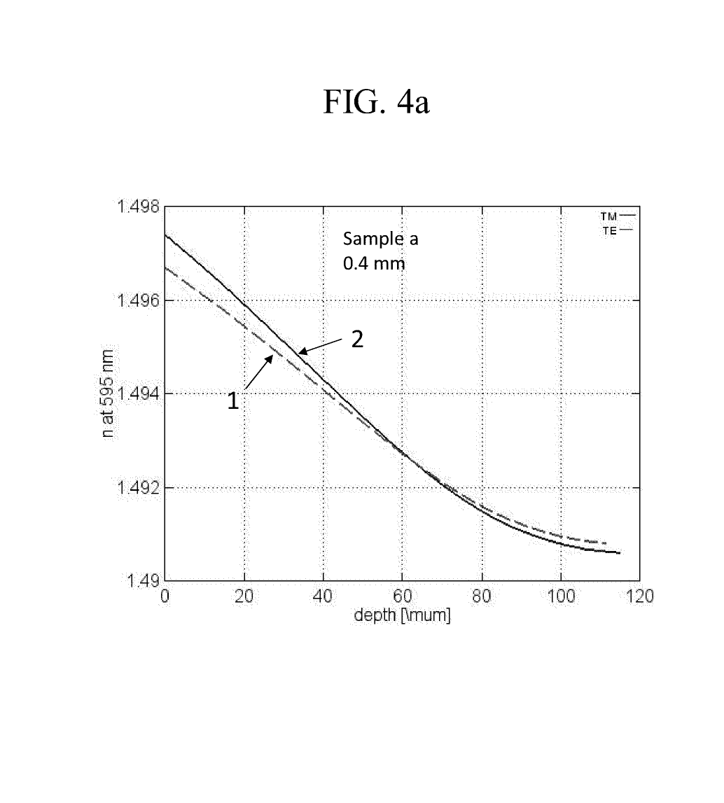

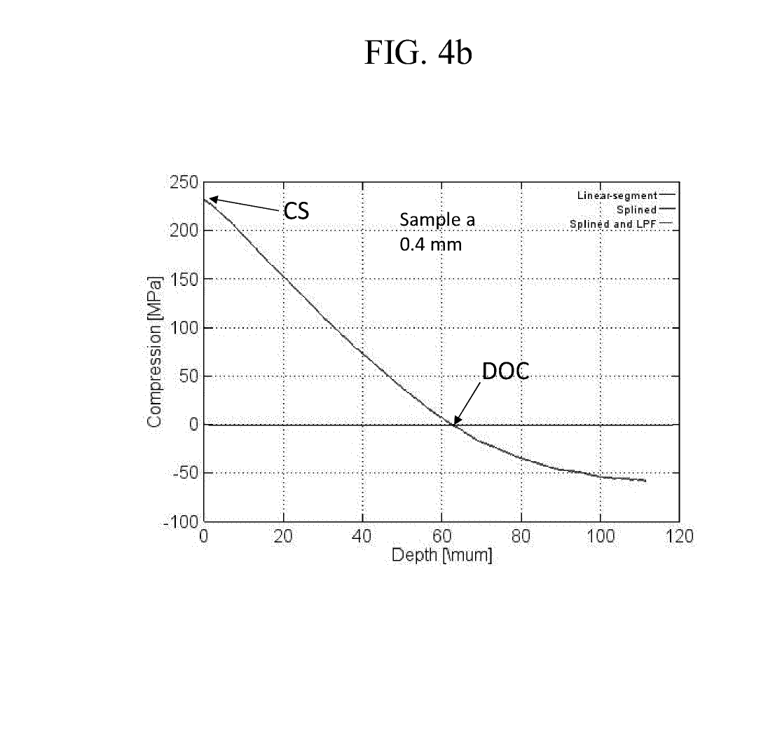

Sample a was ion exchanged at 440° C. for 9 hours in a molten salt bath containing 52% NaNO₃ and 48% KNO₃ by weight. Following ion exchange, the TE and TM mode spectra were measured and the compressive stress profile was determined therefrom. FIG. 4a shows TE (1) and TM (2) index profiles determined from the mode spectra, and FIG. 4b shows the compressive stress profile. The compressive stress profile has a single linear portion analogous to that shown in FIG. 2. The compressive stress CS at the surface and the depth of compression of sample a were determined to be 232 MPa and 63 μm, respectively.

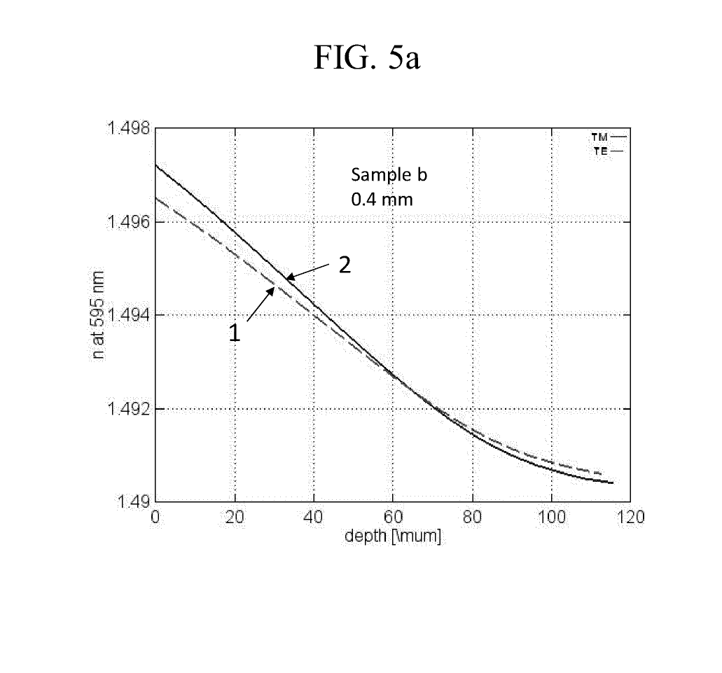

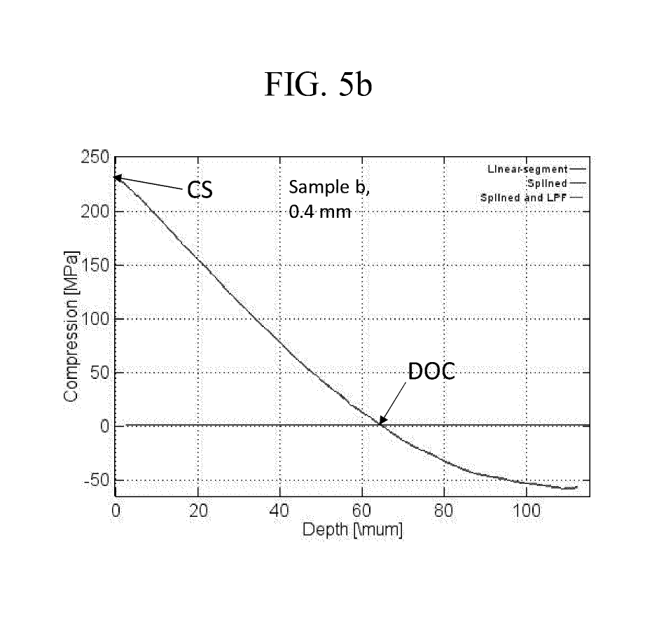

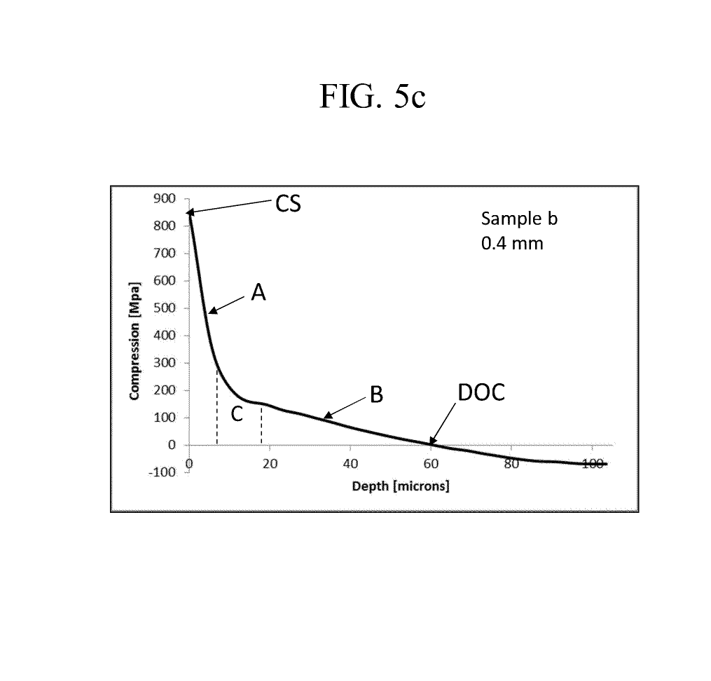

Sample b was ion exchanged at 440° C. for 10 hours in a molten salt bath containing 52% NaNO₃ and 48% KNO₃ by weight. Following ion exchange, the TE and TM mode spectra were measured and the compressive stress profile was determined therefrom. FIG. 5a shows TE (1) and TM (2) index profiles determined from the mode spectra, and FIG. 5b shows the compressive stress profile determined from the mode spectra. The compressive stress profile has a single linear portion analogous to that shown in FIG. 2. The compressive stress CS at the surface and the depth of compression of sample b were determined to be 232 MPa and 65 μm, respectively.

Sample b was then subjected to a second ion exchange at 390° C. for 12 minutes in a molten salt bath containing 1% NaNO₃ and 99% KNO₃ by weight. FIG. 5c shows the compressive stress profile determined from the mode spectra. The compressive stress profile has a first linear segment A extending from the surface of the glass (0 μm depth) to the beginning of a transition region C at about 8 μm and a second linear segment B extending from the end of the transition region C at about 16 μm. The compressive stress profile shown in FIG. 5c is analogous to the stress profile schematically shown in FIG. 3. The compressive stress CS at the surface of the sample and the depth of compression were determined to be 852 MPa and 61 μm, respectively. The slope of segment B of the stress profile is approximately 3.75 MPa/um, whereas the slope of segment B was 89 MPa/um. The transition region C from slope A to slope B ranged from a depth of about 9 μm to about 14 μm.

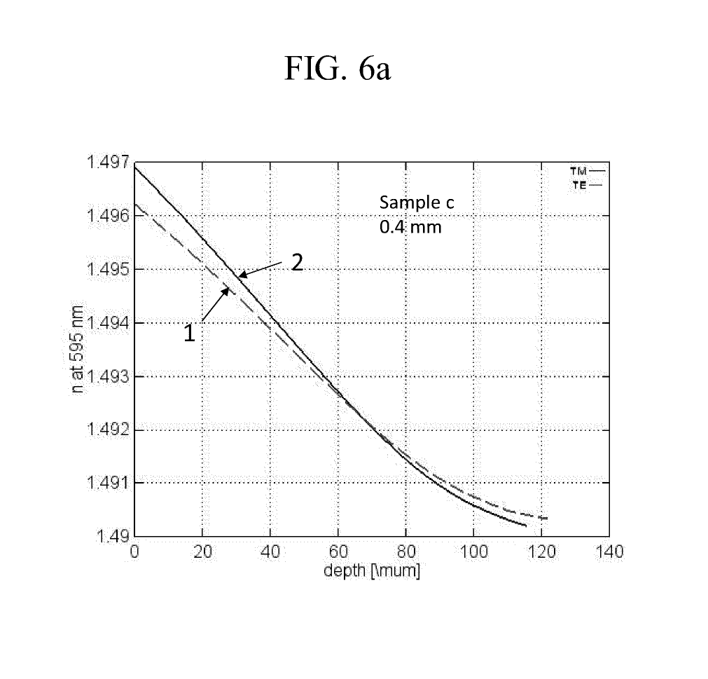

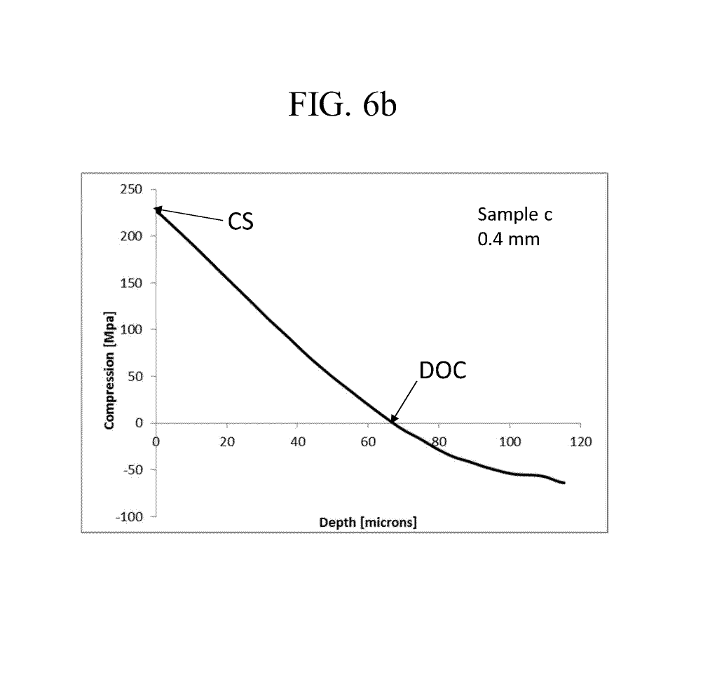

Sample c was ion exchanged at 440° C. for 11.25 hours in a molten salt bath containing 52% NaNO₃ and 48% KNO₃ by weight. Following ion exchange, the TE and TM index profiles determined from the mode spectra were measured and the compressive stress profile was determined therefrom. FIG. 6a shows TE (1) and TM (2) mode spectra, and FIG. 6b shows the compressive stress profile determined from the mode spectra. The compressive stress profile has a single linear portion analogous to that shown in FIG. 2. The compressive stress CS at the surface and the depth of compression of sample c were determined to be 227 MPa and 67 μm, respectively.

### ii) 0.5 mm Thickness

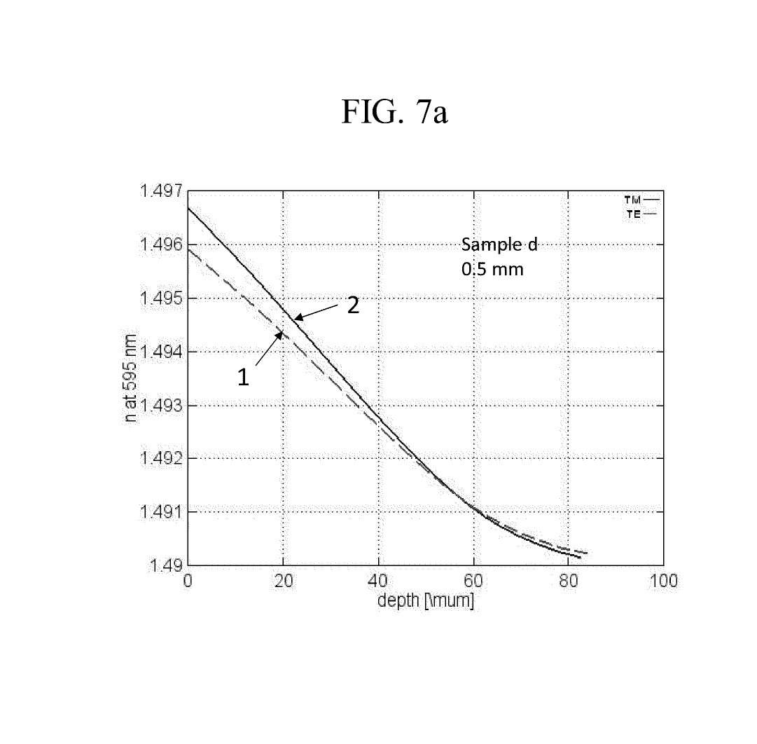

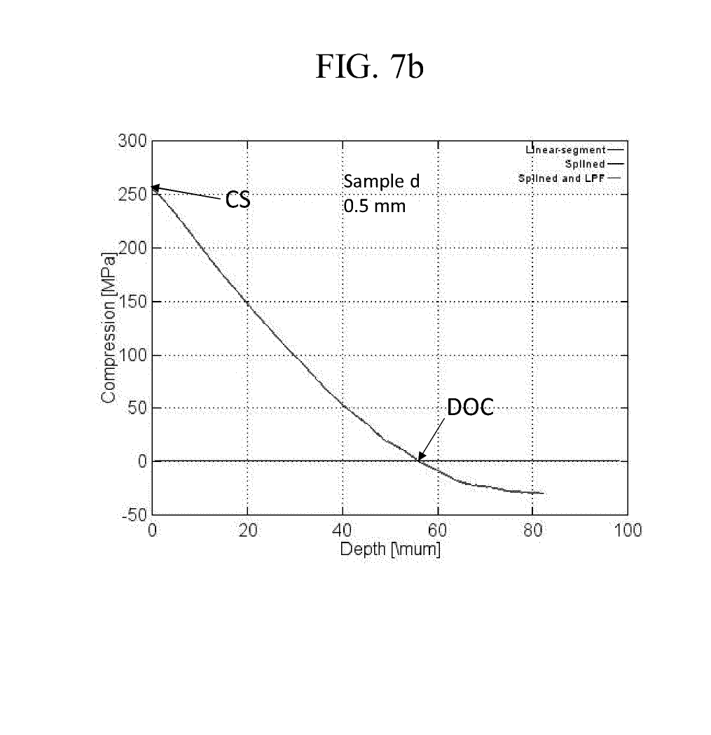

Sample d was ion exchanged at 440° C. for 5.8 hours in a molten salt bath containing 37% NaNO₃ and 63% KNO₃ by weight. Following ion exchange, the TE and TM index profiles determined from the mode spectra were measured and the compressive stress profile was determined therefrom. FIG. 7a shows TE (1) and TM (2) mode spectra, and FIG. 7b shows the compressive stress profile determined from the mode spectra. The compressive stress profile has a single linear portion analogous to that shown in FIG. 2. The compressive stress CS at the surface and the depth of compression of sample d were determined to be 255 MPa and 57 μm, respectively.

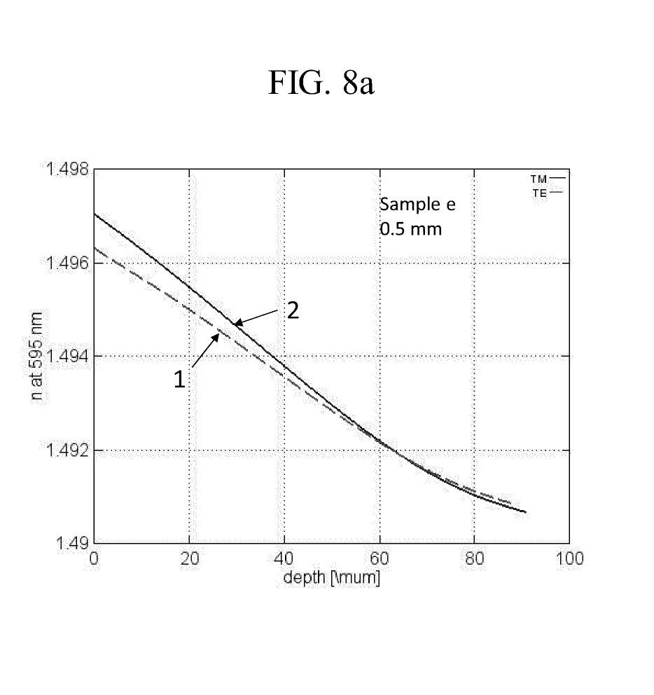

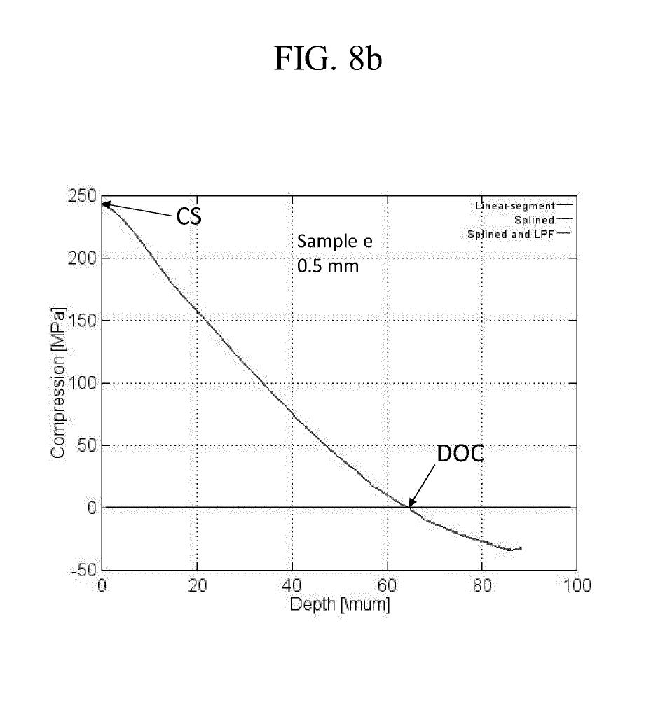

Sample e was ion exchanged at 440° C. for 8.3 hours in a molten salt bath containing 37% NaNO₃ and 63% KNO₃ by weight. Following ion exchange, the TE and TM index profiles determined from the mode spectra were measured and the compressive stress profile was determined therefrom. FIG. 8a shows the TE (1) and TM (2) mode spectra, and FIG. 8b shows the compressive stress profile determined from the mode spectra. The compressive stress profile has a single linear portion analogous to that shown in FIG. 2. The compressive stress CS at the surface and the depth of compression of sample e were determined to be 243 MPa and 66 μm, respectively.

iii) 0.55 mm Thickness

Sample k was first ion exchanged at 450° C. for 7.75 hours in a molten salt bath containing approximately 40% NaNO₃ and 60% KNO₃ by weight. Following ion exchange, the TE and TM mode spectra were measured and the compressive stress profile was determined therefrom. FIG. 13a shows the compressive stress profile determined from the mode spectra. The compressive stress profile has a single linear portion analogous to that shown in FIG. 2. The compressive stress CS at the surface and the depth of compression of sample k after the first ion exchange were determined to be 268 MPa and 73 μm, respectively. The slope of the linear compressive stress profile was 3.7 MPa/um.

Sample k was then subjected to a second ion exchange at 390° C. for 12 minutes in a molten salt bath containing about 0.5% NaNO₃ and 99.5% KNO₃ by weight. FIG. 13b shows the compressive stress profile determined from the mode spectra. Following the second ion exchange, the compressive stress profile had a first linear segment A extending from the surface of the glass to a transition region C at about 8 μm and a second linear segment B extending from the transition region C at about 16 μm to the depth of compression DOC. The compressive stress profile in FIG. 13b is analogous to the stress profile schematically shown in FIG. 3. The compressive stress CS at the surface and the depth of compression of sample k after the second ion exchange were determined to be 896 MPa and 70 μm, respectively. The slope portion A remained at approximately 3.7 MPa/um, whereas the slope of portion B was 86 MPa/um. The transition region C ranged from a depth of about 8 μm to about 16 μm.

### iv) 0.7 mm Thickness

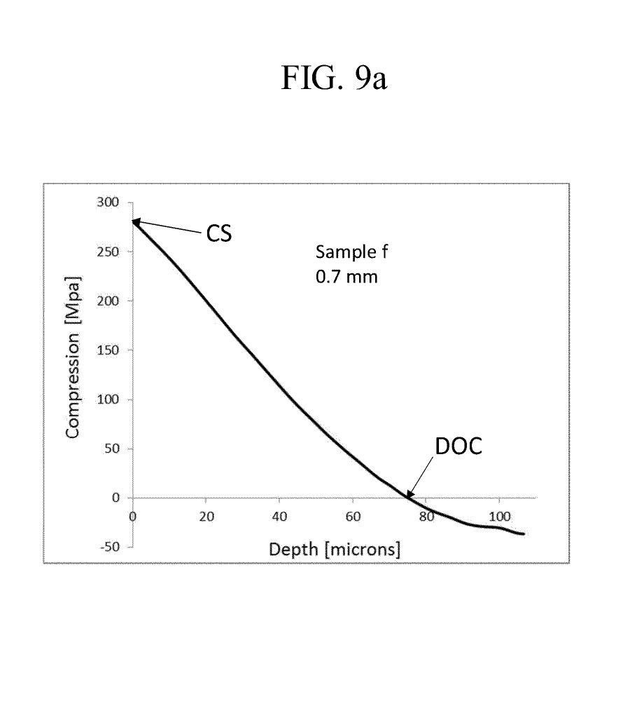

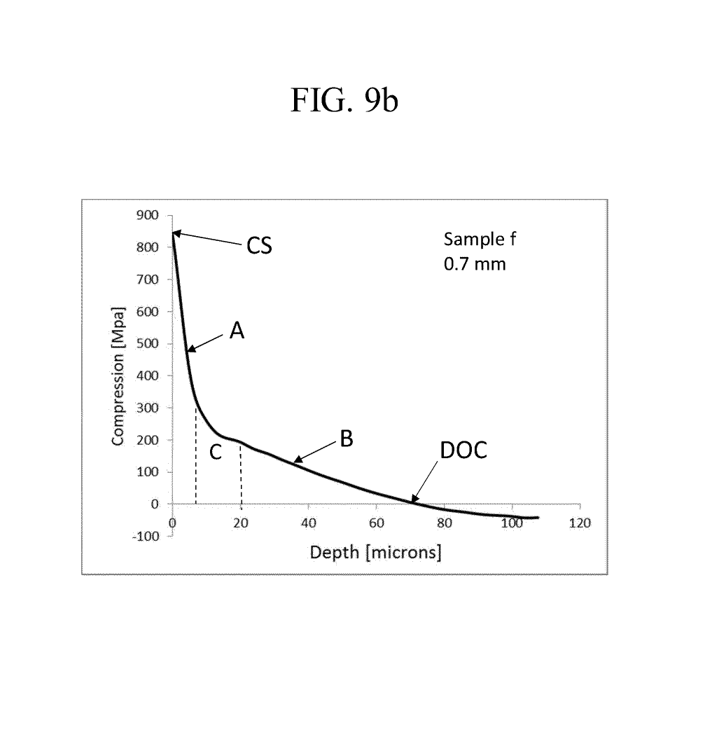

Sample f was first ion exchanged at 450° C. for 8.5 hours in a molten salt bath containing 45% NaNO₃ and 55% KNO₃ by weight. Following ion exchange, the TE and TM mode spectra were measured and the compressive stress profile was determined therefrom. FIG. 9a shows the compressive stress profile determined from the mode spectra. The compressive stress profile has a single linear portion analogous to that shown in FIG. 2. The compressive stress CS at the surface and the depth of compression of sample f after the first ion exchange were determined to be 281 MPa and 75 μm, respectively. The slope of the linear compressive stress profile was 3.75 MPa/um.

Sample f was then subjected to a second ion exchange at 390° C. for 12 minutes in a molten salt bath containing 1% NaNO₃ and 99% KNO₃ by weight. FIG. 9b shows the compressive stress profile determined from the mode spectra. Following the second ion exchange, the compressive stress profile had a first linear segment A extending from the surface of the glass to a transition region C at about 7 μm and a second linear segment B extending from the transition region C at about 15 μm to the depth of compression DOC, and is analogous to the stress profile schematically shown in FIG. 3. The compressive stress CS at the surface and the depth of compression of sample f after the second ion exchange were determined to be 842 MPa and 72 μm, respectively. The slope portion A remained at approximately 3.75 MPa/um, whereas the slope of portion B was 85 MPa/um. The transition region C ranged from a depth of about 7 μm to about 15 μm.

### iv) 0.8 mm Thickness

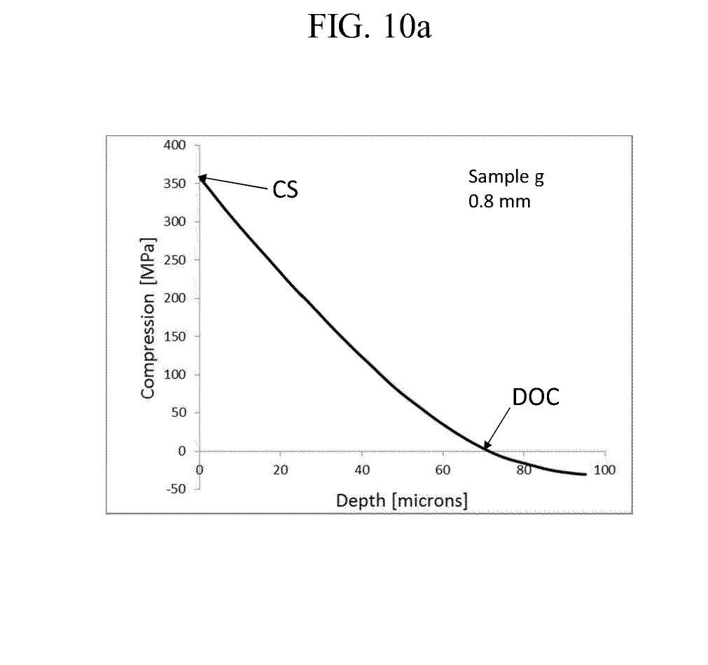

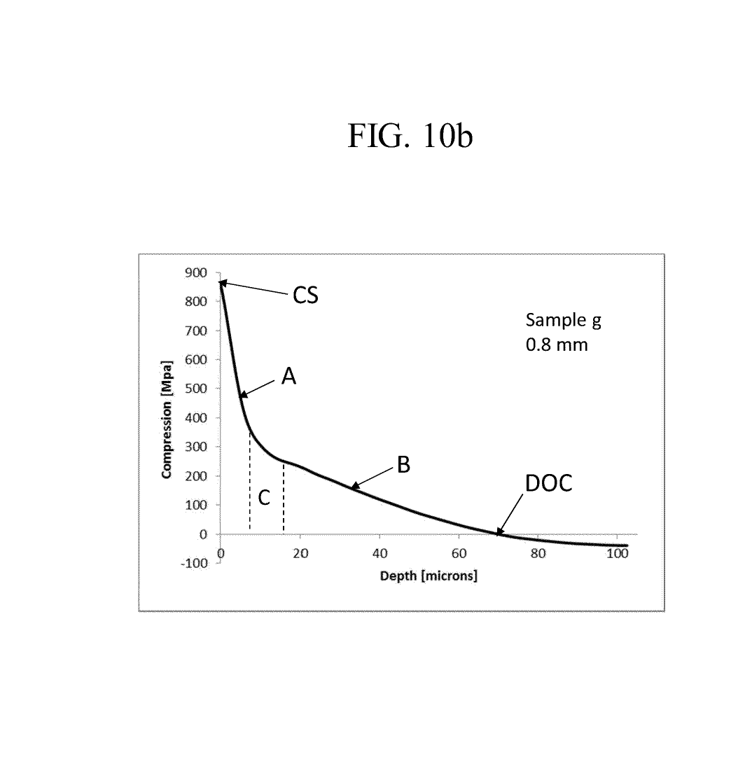

Samples g and h were first ion exchanged at 440° C. for 8.8 hours in a molten salt bath containing 37% NaNO₃ and 63% KNO₃ by weight. Following ion exchange, the TE and TM mode spectra were measured and the compressive stress profile was determined therefrom. FIG. 10a shows the compressive stress profile of sample g determined from the mode spectra following the first ion exchange. The compressive stress profile has a single linear portion analogous to that shown in FIG. 2. The compressive stress CS at the surface and the depth of compression of sample g after the first ion exchange were determined to be 358 MPa and 72 μm, respectively. The slope of the linear compressive stress profile was 5.1 MPa/um.

Sample g was then subjected to a second ion exchange at 319° C. for 12 minutes in a molten salt bath containing 1% NaNO₃ and 99% KNO₃ by weight. FIG. 10b shows the compressive stress profile determined from the mode spectra. Following the second ion exchange, the compressive stress profile had a first linear segment or portion A extending from the surface of the glass to a transition region and a second linear segment B extending from a transition region C to the depth of compression DOC. This is analogous to the stress profile schematically shown in FIG. 3. The compressive stress CS at the surface and the depth of compression of sample g after the second ion exchange were determined to be 861 MPa and 70 μm, respectively. The slope portion B was 4.65 MPa/um, whereas the slope of portion A was 78 MPa/um. The transition region C from slope A to slope B occurred over a range of depths from about 7 μm to about 12 μm.

Following the first ion exchange, sample h was subjected to a second ion exchange at 319° C. for 24 minutes in a molten salt bath containing 1% NaNO₃ and 99% KNO₃ by weight. Following the second ion exchange, the compressive stress profile had a first linear segment A extending from the surface of the glass to a depth of about 5 μm and a second linear segment B extending from the upper boundary of a transition region C at a depth of about 15 μm to a depth of 70 μm. The two segment profile is analogous to the stress profile schematically shown in FIG. 3. The compressive stress CS at the surface and the depth of compression of sample g after the second ion exchange were determined to be 877 MPa and 70 μm, respectively. The slope of segment B was about 5 MPa/um, whereas the slope of portion a was 52 MPa/um. The transition region C from slope A to slope B occurred over a range of depths from about 8 μm to about 15 μm.

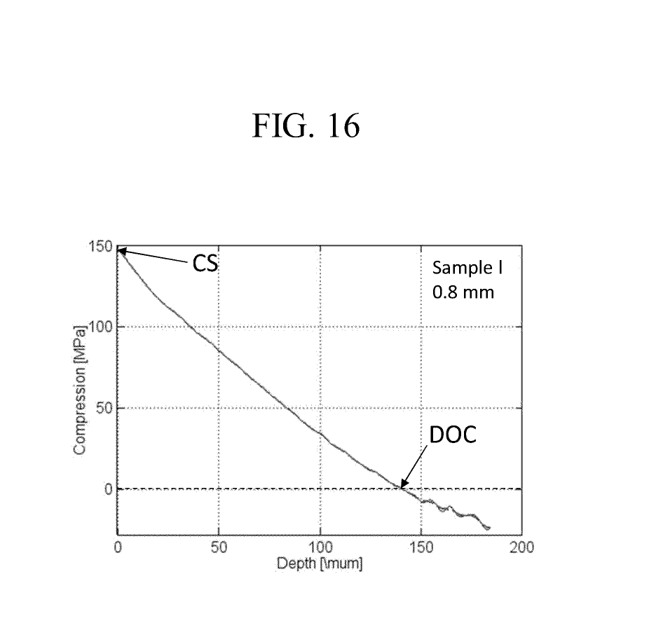

Sample l was first ion exchanged at 450° C. for 48 hours in a molten salt bath containing 69% NaNO₃ and 31% KNO₃ by weight. Following ion exchange, the TE and TM mode spectra were measured and the compressive stress profile was determined therefrom. FIG. 16 shows the compressive stress profile determined from the mode spectra. The compressive stress profile has a single linear portion analogous to that shown in FIG. 2. The compressive stress CS at the surface and the depth of compression of sample l after the first ion exchange were determined to be 146 MPa and 142 μm, respectively. The slope of the linear compressive stress profile was 1.03 MPa/um.

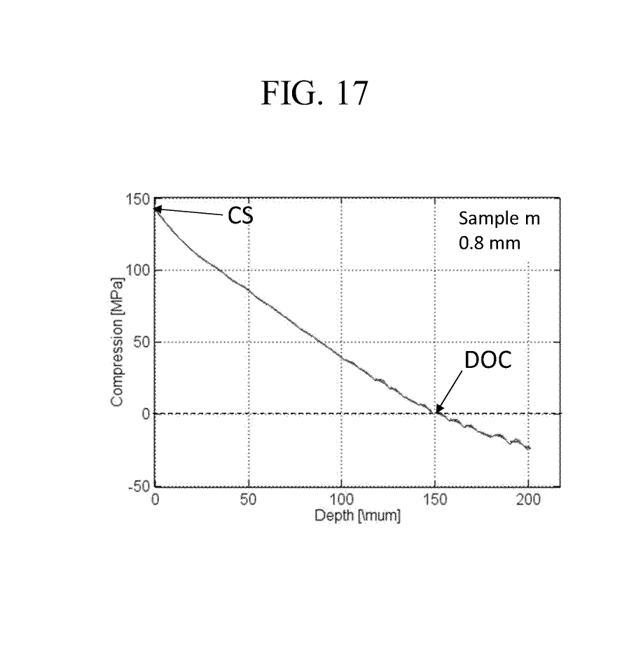

Sample m was first ion exchanged at 450° C. for 65 hours in a molten salt bath containing 69% NaNO₃ and 31% KNO₃ by weight. Following ion exchange, the TE and TM mode spectra were measured and the compressive stress profile was determined therefrom. FIG. 17 shows the compressive stress profile determined from the mode spectra. The compressive stress profile has a single linear portion analogous to that shown in FIG. 2. The compressive stress CS at the surface and the depth of compression of sample m after the first ion exchange were determined to be 140 MPa and 153 μm, respectively. The slope of the linear compressive stress profile was 0.904 MPa/um.

### 0.9 mm Thickness

Sample i was first ion exchanged at approximately 450° C. for about 7.5 hours in a molten salt bath containing 38% NaNO₃ and 62% KNO₃ by weight. Following ion exchange, the TE and TM mode spectra were measured and the compressive stress profile was determined therefrom.

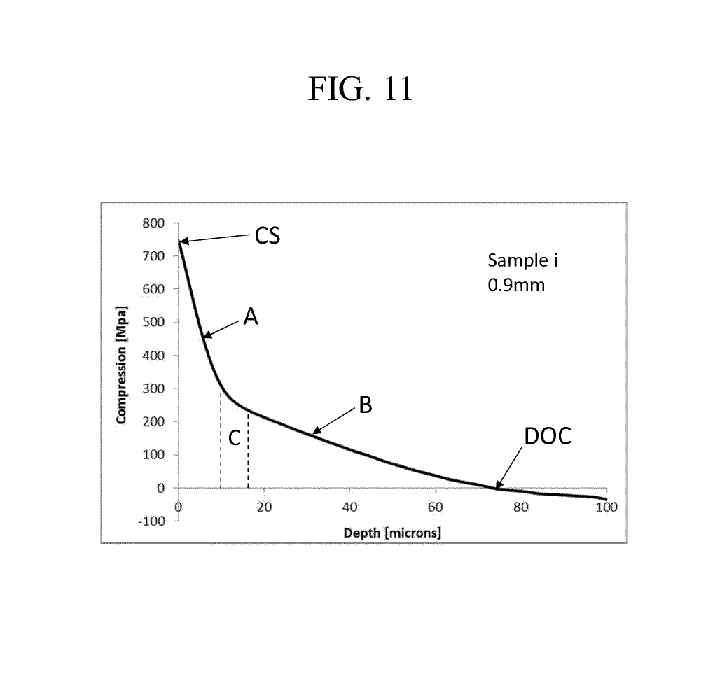

Sample i was then subjected to a second ion exchange at 390° C. for 18 minutes in a molten salt bath containing 2% NaNO₃ and 98% KNO₃ by weight. FIG. 11b shows the compressive stress profile determined from the mode spectra. Following the second ion exchange, the compressive stress profile had a first linear portion A and a second linear portion B, analogous to the stress profile schematically shown in FIG. 3. The compressive stress CS at the surface and the depth of compression of sample h after the second ion exchange were determined to be 746 MPa and 73 μm, respectively. The slope of portion A was approximately 52 MPa/um, whereas the slope of portion B was about 4 MPa/um.

### 1.0 mm Thickness

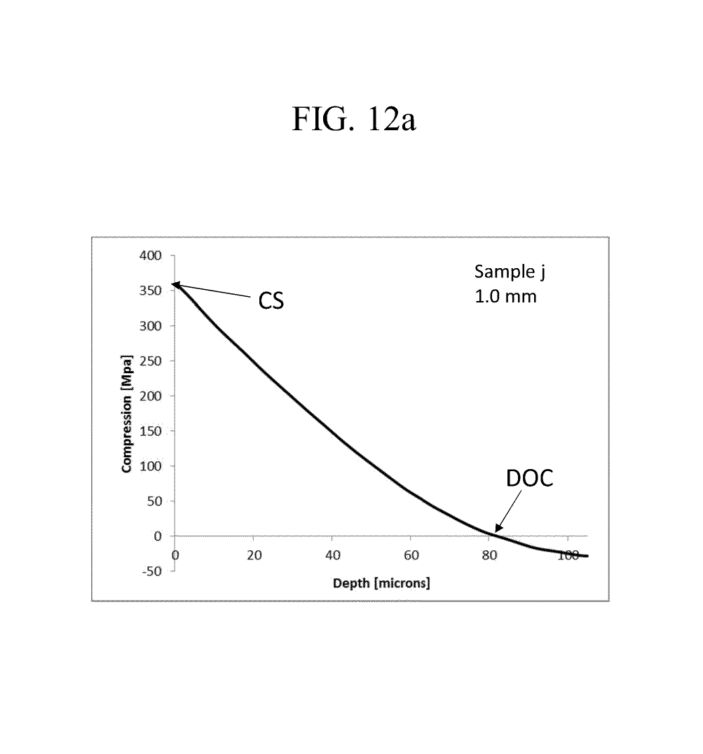

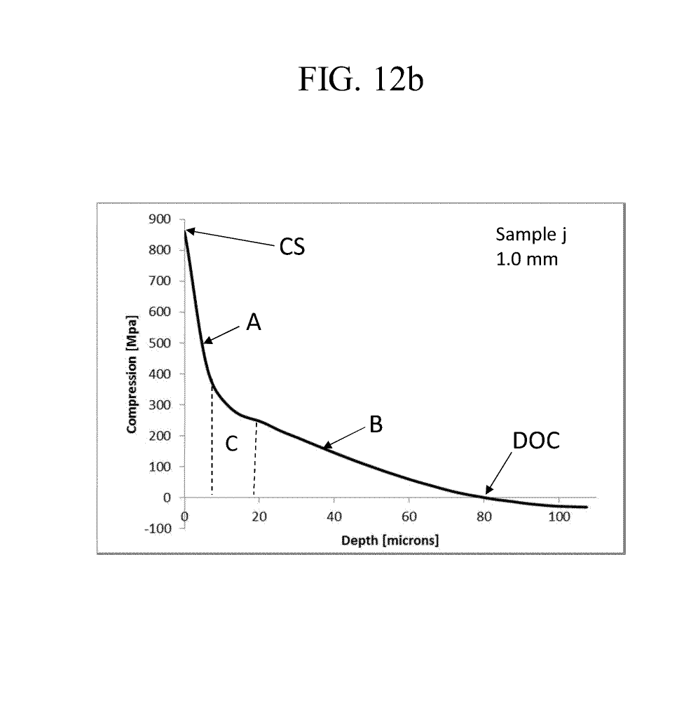

Sample j was first ion exchanged at 440° C. for 11 hours in a molten salt bath containing 37% NaNO₃ and 63% KNO₃ by weight. Following ion exchange, the TE and TM mode spectra were measured and the compressive stress profile was determined therefrom. FIG. 12a shows the compressive stress profile of sample j determined from the mode spectra following the first ion exchange. The compressive stress profile has a single linear segment analogous to the stress profile shown in FIG. 2. The compressive stress CS at the surface and the depth of compression of sample j after the first ion exchange were determined to be 359 MPa and 82 μm, respectively. The slope of the linear compressive stress profile was 5.3 MPa/um.

Sample j was then subjected to a second ion exchange at 390° C. for 12 minutes in a molten salt bath containing 1% NaNO₃ and 99% KNO₃ by weight. FIG. 12b shows the compressive stress profile determined from the mode spectra. Following the second ion exchange, the compressive stress profile had a first linear segment A extending from the surface of the glass to the beginning of a transition region C at about 8 μm and a second linear segment B extending from the end of transition region C at about 16 μm to the depth of compression DOC. This behavior is analogous to the stress profile schematically shown in FIG. 3. The compressive stress CS at the surface and the depth of compression of sample j after the second ion exchange were determined to be 860 MPa and 80 μm, respectively. The slope portion A remained at approximately 5.3 MPa/um, whereas the slope of portion B was 73 MPa/um. The transition region C from slope A to slope B occurred over a range of depths from about 8 μm and about 16 μm.

### Drop Testing

The following examples (Examples 1-3) demonstrate the improved survivability of strengthened alkali aluminosilicate glasses having a DOL≧90 μm by comparison to shallower DOL glasses conventionally used in cover glass.

### Example 1

In the comparative examples, the glass used as a basis for the comparison in the control and experimental glasses below had the following composition in wt %: 58.5% SiO₂, 21.51% Al₂O₃, 5.2% B₂O₃, 13.01% Na₂O, 0.02% K₂O, 1.51% MgO, 0.03% CaO, and 0.18% SnO₂.

As shown in Table 3 below, the control strengthened glass was ion exchanged for 5 hours at 430° C. in a KNO₃ bath to yield a CSₛ=805 MPa, and a DOL=40 μm. The experimental strengthened glass was ion exchanged for 27 hours at 450° in a KNO₃ bath to yield a CSₛ=376 MPa, and a DOL=97 μm in accordance with the present disclosure. These CSₛ and DOL values were computed using FSM. The test method was initially performed beginning at a height of 20 cm and was increased at 10 cm increments for subsequent drops until reaching a maximum height of 220 cm. The drop height for failure was recorded as a metric for both angled drops and flat face drops. The drop surface was a 180 grit sandpaper upper surface disposed on a steel plate. In the tests, the strengthened glass was installed into a commercial smartphone device to best simulate real world dropping conditions. The 30 degree drop and flat (180 degree) drop were oriented with the glass being tested on the device facing the drop surface during impact, so that it was the first surface to make contact with the drop surface.

TABLE 3
Drop test results.

| | Control Strengthened | Experimental |
|---|---|---|
| | Glass | Strengthened Glass |
| DOL (μm) | 40 | 97 |
| Ion Exchange Time (hrs) | 5 | 27 |
| Ion Exchange Temperature | 430 | 450 |
| (° C.) | | |
| Na concentration in KNO₃ | 2% | 29% |
| bath (wt %) | | |

As shown in Table 4 below, strengthened glass with a DOL of 40 μm experienced cover glass fracture at drop heights of 102.5 cm on average for the flat face drop test and 114 cm for the 30° drop tests. However, strengthened glass with a DOL of 97 μm was subjected to 4 drops at 220 cm in the flat face drop tests and 5 drops at 220 cm in the 30° drop tests, and the strengthened glass did not experience cover glass fracture or failure.

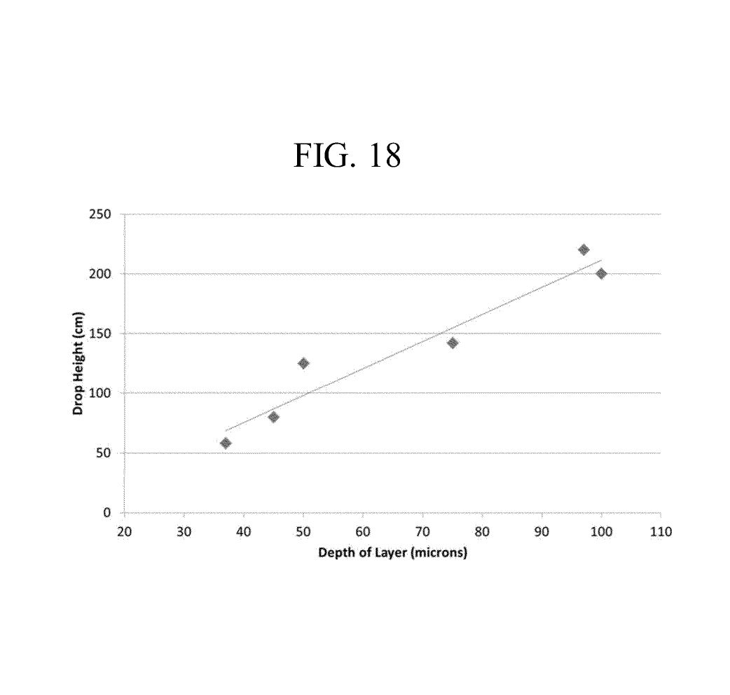

FIG. 18 is a plot of drop height at failure as a function of depth of layer DOL, as measured by FSM, of ion exchanged glass samples. The figure indicates that the depth of the compressive layer correlates with drop height,

TABLE 4
Drop test results for strengthened glass samples.

| DOL | Flat Face Drop | 30 Degree Drop |
|---|---|---|
| (μm) | Avg. Break Height (cm) | Avg. Break Height (cm) |
| 40 | 102.5 | 114 |
| 97 | No Breakage at 220 cm | No Breakage at 220 cm |

### Example 2

Another drop test experiment was conducted for a strengthened glass having a DOL=151 μm using the same procedure as that used in Example 1. The strengthened glass composition in wt % was approximately: 47.93% SiO₂, 23.31% Al₂O₃, 12.73 P₂O₅, 14.37% Na₂O, 1.56% MgO, and 0.11% SnO₂. The glass was ion exchanged to yield approximately a CSₛ=232 MPa, and a DOL=151 μm as computed via FSM. The strengthened glass had a 1 mm thickness and was incorporated into a smartphone device. Upon conducting the same drop testing procedure as in Example 1, the glass survived 5 flat face drops at a 220 cm height, and also survived 5 30° angle drops at a 220 cm height.

### Example 3

In this example, an exemplary 3D shape glass having a thickness of 0.8 mm, dimensions of 55.9 mm×121.0 mm, and a bend radius of 3 mm was tested. The glass had a composition in wt % as follows: 61.22% SiO₂, 16.03 wt % Al₂O₃, 0.62% B₂O₃, 13.85% Na₂O, 3.55% K₂O, 3.7% MgO, 0.5% CaO, 0.52% SnO₂, and 0.1% ZrO₂.

The glass underwent a single ion exchange to yield a CSₛ=787 MPa and a DOL=95 μm as computed via FSM. Flat face drop tests were performed starting at a 30 cm drop height with increasing increments of 10 cm up to a max height of 200 cm. The glass was dropped 4 times from a 200 cm height and demonstrated no breakage or fracture.

### Example 4

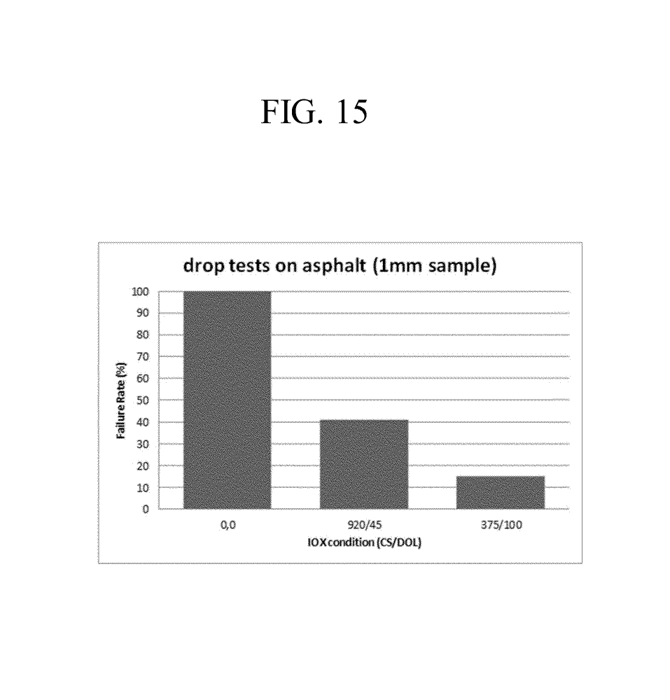

“Real world” comparative drop tests were also conducted on new and aged asphalt. As used herein, “fresh asphalt” is distinguished from “aged asphalt” in that “aged asphalt” has been used for at least one prior drop test. The results of the drop test are shown in FIG. 15. The strengthened glass articles, which included ion exchanged alkali aluminosilicate glass with a thickness of 1 mm, were retrofitted into a commercially available smartphone. The devices were dropped using the drop tester equipment described above for the sandpaper drop test. Further similar to the sandpaper drop test, the devices were dropped on aged or fresh asphalt at a 1 meter height.

In the asphalt drop tests, lower DOL glass samples having a CSₛ of 901 MPa and a DOL of 40 μm had a failure rate of over 40%. In contrast, a deeper DOL glass having a CSₛ of 372 MPa and a DOL of 80 μm experienced a failure rate of approximately 15%.

When FIG. 10 is viewed in conjunction with the results described Example 1, it is apparent that a drop test on 180 grit sandpaper strongly correlates to the “real world” performance of devices on asphalt.

While typical embodiments have been set forth for the purpose of illustration, the foregoing description should not be deemed to be a limitation on the scope of the disclosure or appended claims. Accordingly, various modifications, adaptations, and alternatives may occur to one skilled in the art without departing from the spirit and scope of the present disclosure or appended claims.

1. A glass article, the glass article having a compressive region having a compressive stress CSₛ of at least about 150 MPa at a surface of the glass article, wherein:
a. the compressive region extends from the surface to a depth of compression DOC of at least about 45 μm and has a compressive stress profile; and
b. the compressive region has a compressive stress profile having a first portion a extending to a depth dₐ of at least about 45 μm from the surface and having a slope mₐ, wherein 2 MPa/μm≦mₐ≦8 MPa/μm, and optionally a second portion a′ extending from the surface to a depth d_{a′} of at least about 3 μm, wherein 40 MPa/μm≦m_{a′}≦200 MPa/μm.

2. The glass article of claim 1, wherein the depth dₐ is equal to the depth of compression and first portion a extends from the surface to dₐ.

3. The glass article of claim 2, wherein 3 MPa/μm≦mₐ≦6 MPa/μm.

4. The glass article of claim 2, wherein the depth of compression DOC is at least about 50 μm.

5. The glass article of claim 1, wherein the compressive stress profile includes: the second portion a′ extending from the surface to a depth d_{a′} and the first portion a extending from d_{a′} up to the depth dₐ

6. The glass article of claim 5, wherein 40 MPa/μm≦m_{a′}≦120 MPa/μm.

7. The glass article of claim 1, wherein the glass article has a thickness in a range from about 0.1 mm up to about 1.5 mm.

8. The glass article of claim 7, wherein the thickness is in a range from about 0.1 mm up to about 1.0 mm.

9. The glass article of claim 8, wherein the thickness is in a range from about 0.1 mm up to about 0.5 mm.

10. The glass article of claim 1, wherein the glass article comprises and alkali aluminosilicate glass.

11. The glass article of claim 10, wherein the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

12. The glass article of claim 10, wherein the alkali aluminosilicate glass comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, and wherein B₂O₃(mol %)—(R₂O(mol %)—Al₂O₃(mol %))≧4.5 mol %.

13. The glass article of claim 10, wherein the alkali aluminosilicate glass comprises: the alkali aluminosilicate glass is ion exchangeable and comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %.

14. The glass article of claim 10, wherein the alkali aluminosilicate glass comprises at least about 4 mol % P₂O₅ and from 0 mol % to about 4 mol % B₂O₃, and wherein 1.3<[(P₂O₅+R₂O)/M₂O₃]≦2.3, where M₂O₃═Al₂O₃+B₂O₃, and R₂O is the sum of monovalent cation oxides present in the alkali aluminosilicate glass.

15. The glass article of claim 10, wherein the alkali aluminosilicate glass further comprises up to about 10 mol % Li₂O.

16. The glass article of claim 1, wherein the compressive stress at the surface is at least about 300 MPa.

17. A glass article, the glass article having a compressive layer having a compressive stress CSₛ of at least about 150 MPa at a surface of the glass article, wherein:
a. the compressive layer extends from the surface to a depth of compression DOC of at least about 45 μm and has a compressive stress profile; and
b. the compressive stress profile comprises:
a. a first portion a extending from the surface to a depth dₐ and having a slope mₐ, wherein 3 μm≦dₐ≦8 μm and 40 MPa/μm≦mₐ≦200 MPa/μm; and
b. a second portion b extending from dₐ to up to the depth of compression DOC and having a slope m_{b}, wherein 2 MPa/μm≦m_{b}≦8 MPa/μm.

18. The glass article of claim 17, wherein 40 MPa/μm≦mₐ≦120 MPa/μm.

19. The glass article of claim 17, wherein 50 MPa/μm≦mₐ≦120 MPa/μm.

20. The glass article of claim 17, wherein the glass article has a thickness in a range from about 0.1 mm up to about 1.5 mm.

21. The glass article of claim 20, wherein the thickness is in a range from about 0.1 mm up to about 1.0 mm.

22. The glass article of claim 21, wherein the thickness is in a range from about 0.1 mm up to about 0.5 mm.

23. The glass article of claim 17, wherein the glass article comprises and alkali aluminosilicate glass.

24. The glass article of claim 23, wherein the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

25. The glass article of claim 23, wherein the alkali aluminosilicate glass comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, and wherein B₂O₃(mol %)—(R₂O(mol %)—Al₂O₃(mol %))≧4.5 mol %.

26. The glass article of claim 23, wherein the alkali aluminosilicate glass comprises: the alkali aluminosilicate glass is ion exchangeable and comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %.

27. The glass article of claim 23, wherein the alkali aluminosilicate glass comprises at least about 4 mol % P₂O₅ and from 0 mol % to about 4 mol % B₂O₃, and wherein 1.3<[(P₂O₅+R₂O)/M₂O₃]≦2.3, where M₂O₃═Al₂O₃+B₂O₃, and R₂O is the sum of monovalent cation oxides present in the alkali aluminosilicate glass.

28. The glass article of claim 23, wherein the alkali aluminosilicate glass further comprises up to about 10 mol % Li₂O.

29. The glass article of claim 17, wherein the compressive stress at the surface is at least about 300 MPa.

30. A glass article, the glass article having a compressive region having a compressive stress CSₛ of at least about 150 MPa at a surface of the glass article, wherein:
a. the compressive region extends from the surface to a depth of compression DOC of at least about 45 μm and has a compressive stress profile; and
b. the compressive stress profile has a first linear portion a extending from the surface to a depth dₐ and a slope mₐ, wherein the depth dₐ is equal to the depth of compression and 2 MPa/μm≦mₐ≦8 MPa/μm.

31. The glass article of claim 30, wherein 3 MPa/μm≦mₐ≦6 MPa/μm.

32. The glass article of claim 30, wherein the depth of compression DOC is at least about 50 μm.

33. The glass article of claim 30, wherein the glass article has a thickness in a range from about 0.1 mm up to about 1.5 mm.

34. The glass article of claim 33, wherein the thickness is in a range from about 0.1 mm up to about 1.0 mm.

35. The glass article of claim 34, wherein the thickness is in a range from about 0.1 mm up to about 0.5 mm.

36. The glass article of claim 30, wherein the glass article comprises and alkali aluminosilicate glass.

37. The glass article of claim 36, wherein the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

38. The glass article of claim 36, wherein the alkali aluminosilicate glass comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, and wherein B₂O₃(mol %)—(R₂O(mol %)—Al₂O₃(mol %))≧4.5 mol %.

39. The glass article of claim 36, wherein the alkali aluminosilicate glass comprises: the alkali aluminosilicate glass is ion exchangeable and comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %.

40. The glass article of claim 36, wherein the alkali aluminosilicate glass comprises at least about 4 mol % P₂O₅ and from 0 mol % to about 4 mol % B₂O₃, and wherein 1.3<[(P₂O₅+R₂O)/M₂O₃]≦2.3, where M₂O₃═Al₂O₃+B₂O₃, and R₂O is the sum of monovalent cation oxides present in the alkali aluminosilicate glass.

41. The glass article of claim 36, wherein the alkali aluminosilicate glass further comprises up to about 10 mol % Li₂O.

42. The glass article of claim 30, wherein the compressive stress at the surface is at least about 300 MPa.

43. A glass article, the glass article having a compressive region having a compressive stress CSₛ of at least about 130 MPa at a surface of the glass article, wherein:
a. the compressive region extends from the surface to a depth of compression DOC of at least about 100 μm and has a compressive stress profile; and
b. the compressive stress profile has a first linear portion a extending from the surface to a depth dₐ and a slope mₐ, wherein the depth dₐ is equal to the depth of compression and 0.7 MPa/μm≦mₐ≦2.0 MPa/μm.

44. The glass article of claim 43, wherein the depth of compression DOC is at least about 140 μm.

45. The glass article of claim 43, wherein the glass article has a thickness in a range from about 0.1 mm up to about 1.5 mm.

46. The glass article of claim 45, wherein the thickness is in a range from about 0.1 mm up to about 1.0 mm.

47. The glass article of claim 46, wherein the thickness is in a range from about 0.1 mm up to about 0.5 mm.

48. The glass article of claim 43, wherein the glass article comprises and alkali aluminosilicate glass.

49. The glass article of claim 48, wherein the alkali aluminosilicate glass comprises: from about 60 mol % to about 70 mol % SiO₂; from about 6 mol % to about 14 mol % Al₂O₃; from 0 mol % to about 15 mol % B₂O₃; from 0 mol % to about 15 mol % Li₂O; from 0 mol % to about 20 mol % Na₂O; from 0 mol % to about 10 mol % K₂O; from 0 mol % to about 8 mol % MgO; from 0 mol % to about 10 mol % CaO; from 0 mol % to about 5 mol % ZrO₂; from 0 mol % to about 1 mol % SnO₂; from 0 mol % to about 1 mol % CeO₂; less than about 50 ppm As₂O₃; and less than about 50 ppm Sb₂O₃; wherein 12 mol %≦Li₂O+Na₂O+K₂O≦20 mol % and 0 mol %≦MgO+CaO≦10 mol %.

50. The glass article of claim 48, wherein the alkali aluminosilicate glass comprises: at least about 50 mol % SiO₂; at least about 10 mol % R₂O, wherein R₂O comprises Na₂O; Al₂O₃, wherein −0.5 mol %≦Al₂O₃(mol %)—R₂O(mol %)≦2 mol %; and B₂O₃, and wherein B₂O₃(mol %)—(R₂O(mol %)—Al₂O₃(mol %))≧4.5 mol %.

51. The glass article of claim 48, wherein the alkali aluminosilicate glass comprises: the alkali aluminosilicate glass is ion exchangeable and comprises: at least about 50 mol % SiO₂; at least about 10 mol % R₂O, wherein R₂O comprises Na₂O; Al₂O₃; and B₂O₃, wherein B₂O₃—(R₂O—Al₂O₃)≧3 mol %.

52. The glass article of claim 48, wherein the alkali aluminosilicate glass comprises at least about 4 mol % P₂O₅ and from 0 mol % to about 4 mol % B₂O₃, and wherein 1.3<[(P₂O₅+R₂O)/M₂O₃]≦2.3, where M₂O₃═Al₂O₃+B₂O₃, and R₂O is the sum of monovalent cation oxides present in the alkali aluminosilicate glass.

53. The glass article of claim 48, wherein the alkali aluminosilicate glass further comprises up to about 10 mol % Li₂O.

54. The glass article of claim 48, wherein the alkali aluminosilicate glass further comprises up to about 0.5 mol % Li₂O.

55. A method of producing a strengthened glass article having at least one compressive stress layer extending from a surface of the strengthened glass article to a depth of compression DOC of at least about 45 μm, the method comprising:
a. conducting a first ion exchange step by immersing an alkali aluminosilicate glass article in a first ion exchange bath at a temperature of greater than 400° C. for a time sufficient such that the compressive stress layer has a depth of at least 45 μm after the first ion exchange step; and
b. conducting a second ion exchange step by immersing the alkali aluminosilicate glass article in a second ion exchange bath different from the first ion exchange bath at a temperature of at least about 350° C. for a time sufficient to produce the compressive layer having the depth of compression DOC of at least about 45 μm.

56. The method of claim 55, wherein the first ion exchange step is conducted for a time of at least 8 hours.

57. The method of claim 55, wherein the first ion exchange bath delivers sodium ions to the alkali aluminosilicate glass article and comprises at least about 30% by weight of a sodium salt with the balance of the ion exchange bath comprising a potassium salt a potassium salt.

58. The method of claim 57, wherein the first ion exchange bath comprises from about 40% to about 60% by weight of the sodium salt.

59. The method of claim 55, wherein the temperature of the first ion exchange step is 440° C. or greater.

60. The method of claim 55, wherein the strengthened glass article has a compressive stress at the surface of at least 150 MPa after the first ion exchange step.

61. The method of claim 60, wherein the compressive stress at the surface is in a range from about 200 to about 300 MPa after the first ion exchange step.

62. The method of claim 55, wherein the second ion exchange step is conducted for a time of 60 minutes or less.

63. The method of claim 50, wherein the second ion exchange step is conducted for a time of about 10 to about 30 minutes.

64. The method of claim 55, wherein the second ion exchange bath comprises at least about 95% by weight of a potassium composition that delivers potassium ions to the alkali aluminosilicate glass article.

65. The method of claim 64, wherein the second ion exchange bath comprises from about 98% to about 99.5% by weight of the potassium composition.

66. The method of claim 64, wherein the second ion exchange bath comprises 0-2% by weight of a sodium composition.

67. The method of claim 55, wherein the temperature of the second ion exchange step is 390° C. or greater.

68. The method of claim 55, wherein the strengthened glass article has a compressive stress of at least about 700 MPa after the second ion exchange step.

69. The method of claim 68, wherein the compressive stress is in a range from about 700 to about 1000 MPa after the second ion exchange step.

70. The method of claim 69, wherein the compressive stress layer has a depth of compression of at least about 60 μm after the first ion exchange step.

71. The method of claim 70, wherein the depth of compression is in a range from about 90 μm to about 130 μm after the second ion exchange step.

72. The method of claim 55, wherein the first ion exchange step produces a compressive stress profile having a first portion a extending from the surface to a depth dₐ and a slope mₐ, wherein the depth dₐ is equal to the depth of compression and 2 MPa/μm≦mₐ≦8 MPa/μm.

73. The method of claim 55, wherein the second ion exchange step produces a compressive stress profile comprising:
a. a first portion a extending from the surface to a depth dₐ and having a slope mₐ, wherein 3 μm≦dₐ≦8 μm and 40 MPa/μm≦mₐ≦200 MPa/μm; and
b. a second portion b extending from dₐ to up to the depth of compression DOC and having a slope m_{b}, wherein 2 MPa/μm≦m_{b}≦8 MPa/μm.
